(19) United States
(12) Patent Application Publication
(10) Pub. No.: US 2024/0311858 A1
(43) Pub. Date: Sep. 19, 2024

(54) INTELLECTUAL-PROPERTY ANALYSIS PLATFORM

(71) Applicant: AON RISK SERVICES, INC. OF MARYLAND, New York, NY (US)

(72) Inventors: Joseph Dumoulin, Spokane, WA (US); Timothy Seegan, Spokane, WA (US); Michael John Tobias, Spokane, WA (US); Josie Isaacson, Spokane, WA (US)

(21) Appl. No.: 18/120,966

(22) Filed: Mar. 13, 2023

(51) Int. Cl. G06Q 30/0201; G06Q 30/0202; G06Q 50/18

(52) U.S. Cl. CPC G06Q 30/0206; G06Q 30/0202; G06Q 50/184

(57) ABSTRACT

Systems and methods for generation and use of intellectual-property (IP) analysis platform architectures are disclosed. A scoring component may be utilized to produce scores for IP assets using user seeded searches in varying areas of interest, such as, for example, target markets, target technical fields, targeted publications, targeted products, and/or entity portfolios. The scoring component may be further utilized to produce an interactive graphical element including a spatial representation of the scoring of IP assets. The interactive graphical element may include various functionalities and/or information associated with the of IP assets. The scoring component may utilize data from a number of other components and/or sub-component to generate an innovation metric associated with a group of IP assets of a targeted entity, market, and/or technology space.

### BACKGROUND

Analyzing an intellectual-property portfolio of a particular entity and/or technology area with respect to one or more entities having a similar intellectual-property portfolio may provide various insights and can be valuable. However, it can be difficult to identify information that can be derived from data that has rarely been analyzed and it can also be challenging to determine which types of data can be utilized to make decisions. Disclosed herein are improvements in technology and solutions to technical problems that can be used to, among other things, analyze and generate visual representations of intellectual-property portfolios of various entities and/or technology areas.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for an intellectual-property analysis platform architecture.

FIG. 2 illustrates a component diagram of example components of a remote computing resource for the intellectual-property analysis platform.

FIG. 3 illustrates an example user interface for displaying data associated with a user account representing intellectual-property metric data and/or one or more actionable elements.

FIG. 4 illustrates an example user interface for displaying data associated with a user account representing an intellectual-property metric data associated with a technology space and/or market.

FIG. 5 illustrates an example user interface for displaying data associated with a user account representing an intellectual-property metric data associated with an entity.

FIG. 6 illustrates an example user interface for displaying data associated with a user account representing an intellectual-property metric data associated with a technology space and/or market.

FIGS. 7A-7C illustrate an example flow diagram of an example process for generating data representing IP asset and data representing an innovation metric on a graphical user interface.

FIGS. 8A and 8B illustrate an example flow diagram of an example process for generating data representing IP asset and data representing an innovation metric on a graphical user interface.

FIG. 9 illustrates an example flow diagram of an example process for generating data representing IP asset and data representing an innovation metric on a graphical user interface.

### DETAILED DESCRIPTION

Systems and methods for generation and use of an intellectual-property analysis platform are disclosed. Take, for example, an entity that would find it beneficial to utilize a platform to analyze a corpus of intellectual-property (IP) assets in an efficient manner by targeting technical fields, subject matters, and/or entities and to determine an innovation metric that can be used for identifying a potential market opportunity associated with the IP assets included in the targeted technical fields, subject matters, and/or entities portfolios. For example, an entity may desire to know an innovation metric associated with the IP assets associated with a technical field, a subject matter, and/or entities for patentability determinations, for infringement determinations, for asset acquisition purposes, for research and development purposes, for insurance purposes, and the like. Generally, a user may search a database of such documents using keyword searching, such as, for example, a technical term, a target product, or an identifier of a target entity. To gather a reasonable number of results that does not unduly limit the documents in those results, users may employ broad keyword searching and then review each document to determine whether each document should be considered in class or out of class for the purposes at hand. However, taking patents and patent applications as an example, the potential corpus of documents, even if looking just to patents and patent applications filed in the United States, easily numbers in the thousands if not tens of thousands or more. Additionally, grouping the patents into groupings based on one or more shared technical fields, subject matters, and/or by similar entities may become cumbersome, especially when dealing with a large corpus. In light of this, an IP analysis platform that is configured to identify IP assets that may be determined to be similar to the IP portfolio of one or more target entities, one or more target publications, and/or one or more target products and/or services and generate multiple result sets of varying levels of granularity would be beneficial. Additionally, an interactive graphical element including a spatial representation of the metrics associated with the IP assets may be desirable to accurately and efficiently visualize an analysis of the IP assets.

Described herein is an IP analysis platform that is configured to produce a qualitative analysis of IP assets using asset data obtained from a number of different sources in varying areas of interest, such as, for example, target technical fields, targeted publications, targeted products, and/or entity portfolios. The platform may include a scoring component that may include various sub-components, such as, a coverage component, an opportunity component, an exposure component, and a data store. In some examples, the coverage component may include various sub-components, such as, a geographic distribution component, an expiration component, a comprehensive breadth score component, a diversity component, a revenue alignment component and/or an invalidity component. In some cases, the opportunity component may include various sub-components, such as, a filing velocity component, a predictive analytics component, a precedence component, and/or an innovation component. In some examples, the exposure component may include various sub-component, such as, a litigation campaign component and/or an alignment to exposure component. In some examples, the datastore may be a secure datastore accessible by the system and utilized to securely store user account data including a project library, an IP asset library including one or more IP assets, and/or historical data. The IP analysis platform may be accessible to users via one or more user interfaces that may be configured to display information associated with analysis report(s) associated with a user account of the user and/or one or more user account(s) associated with the user account. Additionally, or alternatively, the user interface(s) may be configured to receive user input.

The IP analysis platform may be configured to display a user interface for presenting information associated with the analysis report(s) and/or analysis associated with the user account. For example, the user interface may include selectable portions that when selected, may present information associated with the coverage component, the opportunity component, and/or the exposure component. Additionally, or alternatively, the IP analysis platform may be configured to cause the user interface to present information associated with the coverage component, the opportunity component, and/or the exposure component using different views. Additionally, or alternatively, the user interface(s) may include one or more information windows for presenting information associated with the analysis report(s) associated with the user account.

When a user accesses the IP analysis platform using a user account, the user interface may be caused to display one or more pages that present portions of the information associated with the coverage component, the opportunity component, and/or the exposure component using information windows that are relevant to that page. Pages that may be accessed by a user account may include for example, comprehensive score page, a market analysis page, an IP to revenue alignment page, a comprehensive breadth score page, a geographic distribution page, a litigation trend page, a litigation campaign page, a filing velocity page, an innovation metric page, and/or the like. As mentioned above, each page presents information using information windows that are relevant to that page.

In some examples, the comprehensive score page may include a number of views that may be presented in response to selection of a corresponding view selection element. For example, the comprehensive score page may display a comprehensive score indicating an IP coverage associated with the IP asset portfolio and/or a subset of the IP asset portfolio. The comprehensive score page may also display a coverage score (e.g., coverage metric), an opportunity score (e.g., an opportunity metric), and an exposure metric (e.g., an exposure metric) that are used by the IP analysis platform to generate the comprehensive score. The comprehensive score page may also include other information (e.g., company name, location, website, revenue data, employee data, and/or summary data) associated with an entity in which the analysis report is based on.

In some examples, the market analysis page may include a number of views that may be presented in response to selection of a corresponding view selection element. For example, the market analysis page may display one or more markets associated with a technology area (e.g., music and video, smartphones, business/personal, wearable technology, tablets, etc.) as well as one or more metrics generated by the sub-components of the IP analysis platform. For example, the market analysis page may display a comprehensive breadth score associated with IP assets that are directed towards each market and/or technology area, a research and development value spent by an entity that was directed towards each market and/or technology area, a revenue value generated by an entity from each market and/or technology area, and/or a percentage of IP assets associated with an entity that are directed towards each market and/or technology area.

In some examples, the IP to revenue alignment page may include a number of views that may be presented in response to selection of a corresponding view selection element. For example, the revenue alignment page may display one or more markets associated with a technology area (e.g., music and video, smartphones, business/personal, wearable technology, tablets, etc.) as well as one or more metrics generated by the sub-components of the IP analysis platform. In some cases, the IP revenue alignment page may illustrate a revenue generated by an entity from each of the markets and/or technology areas. The revenue alignment page may also display an indication of a percentage of revenue generated in a market and/or technology area of a total amount of revenue generated by the entity to a percentage of intellectual-property assets directed to the one or more technology areas from a total amount of intellectual-property assets filed by the entity. In some examples, the IP to revenue alignment page may display an indication of a percentage of revenue obtained by other entities for each of the markets and/or technology areas and the percentage of intellectual-property assets associated with the other entities directed towards the markets and/or technology areas.

In some examples, the comprehensive breadth score page may include a number of views that may be presented in response to selection of a corresponding view selection element. For example, the comprehensive breadth score page may display one or more markets associated with a technology area (e.g., music and video, smartphones, business/personal, wearable technology, tablets, etc.) as well as one or more metrics generated by the sub-components of the IP analysis platform. In some cases, the metrics may include a comprehensive breadth score associated with IP assets directed to each of the markets and/or technology areas as well as an overall (e.g., total) comprehensive breadth score for the total IP assets (e.g., the IP asset portfolio). In some cases, the comprehensive breadth scores may be plotted on a line graph illustrating how the comprehensive breadth scores have changed year-to-year for each market and/or technology area. The comprehensive breadth score page may also illustrate values associated with the IP assets of a given entity, such as number active worldwide IP assets, number of active U.S. IP assets, number of IP asset families, and/or average age of an IP asset.

In some examples, the geographic distribution page may include a number of views that may be presented in response to selection of a corresponding view selection element. For example, the geographic distribution page may present a map showing regions in which portions of IP assets from an IP asset portfolio of an entity are filed. In some cases, the geographic distribution page may further present a table illustrating pending IP assets and granted IP assets and the associated regions in which they have been filed.

In some examples, the litigation trend page may include a number of views that may be presented in response to selection of a corresponding view selection element. For example, the litigation trend page may present litigation data (e.g., amount of defendant damages, amount of plaintiff cases, amount of defendant cases, average case duration, etc.) associated with an entity, a market, and/or technology area. In some cases, the litigation data may be plotted in a line graph over a period of time (e.g., 1 year, 5 years, 10 years, etc.). In some cases, the line graphs may be collapsible or expandable.

In some examples, the litigation campaign page may include a number of views that may be presented in response to selection of a corresponding view selection element. For example, the litigation campaign page may illustrate litigation campaign data associated with a particular market and/or technology area. In some cases, the litigation campaign data may be a graphic, such as a, for example, a heatmap, a bar graph, a line graph, and/or any trend analysis graph. In some examples the graphic may include a bubble (e.g., a circle) illustrating an identified litigation campaign. In some cases, different aspects of the bubble may represent different characteristics of the litigation campaign. For example, a size of the circle may correspond to a total number of defendants targeted in the litigation campaign, a color of the circle may indicate a non-practicing entity (NPE) status of the litigation campaign, the x-axis may represent the number of days since the filing of the most recent case in the litigation campaign, and the y-axis may represent a total number of cases filed in the litigation campaign.

In some examples, the compliance page may include a number of views that may be presented in response to selection of a corresponding view selection element. For example, a graphic may include a data graph, such as, for example, a heatmap, a bar graph, a line graph, and/or any trend analysis graph. For example, the graphic may include a heat map comprised of cells, each cell indicating a level of exposure associated with a grouping of supply relationships between a client and its vendors. The level of exposure may be based on an amount of annual spending between a client and a vendor, a level of compliance exposure associated with a vendor account, and/or an age of the vendor account and/or the contract associated with the client account and the vendor account. For example, a client that has entered into a supply contract with a vendor in which the annual amount of spending is high relative to additional annual amounts of spending associated with additional supply contracts, and the vendor account has a low level of compliance with the contract associated with the client, then the relationship between the client account and that vendor account may be represented as a high level of exposure on the heatmap. Additionally, or alternatively, as that supply contract ages, then the level of exposure representing the relationship between the client account and the vendor account may continue to increase. Additionally, or alternatively, each cell of the heatmap may include a visual indication of the exposure level, such as, for example, a color. Additionally, or alternatively, each cell of the heatmap may include an indication of the amount of spending between the client account and each of the vendor accounts that are associated with that cell. Additionally, or alternatively, each cell of the heatmap may include an indication of the age of an associated supply contract and/or an amount of time a vendor account has resided in that cell (exposure category). In some examples, the compliance page may include a compliance overview window including content to provide an indication of the number of compliant vendor accounts that are associated with the client account. Additionally, or alternatively, the compliance overview window may include content to provide an indication of the number of non-compliant vendor accounts that are associated with the client account. In some examples, the content may include a percentage, a graphic indicating the number, or the like. Additionally, or alternatively, the compliance overview window may include one or more compliance indication windows that may include an indication of the number of vendor accounts associated with the client account that are pending registration, the number of vendor accounts associated with the client account that are pending contract acceptance, and/or the number of vendor accounts associated with the client account that have non-compliant insurance.

In some examples, the filing velocity page may include a number of views that may be presented in response to selection of a corresponding view selection element. For example, the filing velocity page may present a graph showing a number of IP assets filed by an entity directed towards a particular market and/or technology area with respect to a total number of IP assets filed that were directed towards the particular market and/or technology area. In some cases, the filing velocity page may illustrate other entities that have filed IP assets directed towards the particular market and/or technology area with respect to the total number of IP assets filed that were directed towards the particular market and/or technology area. In some cases, the filing velocity page may receive user input to switch which markets and/or technology areas and/or select sub-categories within a market and/or technology area.

In some examples, the innovation metric page may include a number of views that may be presented in response to selection of a corresponding view selection element. For example, the IP analysis platform may determine an innovation metric associated with an entity, a technology area, and/or a market. The innovation metric may indicate different types of innovation associated with the entity, the technology area, and/or the market. For example, an innovation metric may be associated with different types of innovation, such as, but not limited to, radical innovation, disruptive innovation, architectural innovation, and/or incremental innovation. A radical innovation metric may indicate that the entity, the technology area, and/or the market is associated with a new product or service being developed using a new technology that opens up to new markets. For example, pharmaceutical researchers often produce a new product that is radical innovation such as a new combination of chemicals to treat a medical condition that attracts new buyers. A disruptive innovation metric may indicate and/or otherwise be associated with innovation that conflicts with, and threatens to replace, traditional approaches to competing within an industry. Disruptive innovation occurs when a new product or service engages the existing market with a new technology. For example, digital cameras disrupted the photography industry by offering instant gratification and eliminating the cost of getting film developed. An architectural innovation metric may indicate and/or otherwise be associated with new products or services that use existing technology to create new markets and/or new consumers that did not purchase that item before. For example, smart watch used existing cell phone technology and was repackaged into a watch. An incremental innovation metric may indicate and/or otherwise be associate with improvements on an existing product or service. The improvements may be based on using existing technology and are directed at the existing market. For example, residential washers and dryers have been transitioning from top-loading to side-loading, and can handle larger loads. This incremental innovation used existing technology and created no new markets, but stimulated demand for more purchasers at higher prices. In some cases, the innovation metric page may display an innovation metric associated with an entity, a technology area, and/or a market such that a user, such as a potential investor, may understand which markets are most innovative (e.g., markets that fall into a radical innovation category or a disruptive innovation category), which companies are efficiently innovating (e.g., companies that are producing intellectual-property that is contributing to revenue grown while efficiently using research and development spending), among other types of information.

As mentioned above, the IP analysis platform may include a datastore. In some examples, the datastore may include data corresponding to user accounts, projects, IP assets, historical data, saved results from previous interactions the user account has made with the IP analysis platform, and/or market data. The analysis report(s) may include, for example, coverage metric results, opportunity metric results, exposure metric results, seeded search queries, similarity results, comprehensive breadth score results, revenue alignment results, filing velocity results and/or litigation campaign results. The analysis report(s) may be stored with respect to the user account(s). The IP asset(s) may be stored with respect to an IP asset library. In some examples, the IP asset library may include data associated with IP assets and/or related to a corresponding IP asset, such as, for example, licensing data, and/or standard essential patent data. The historical data may be stored with respect to the user account(s) and/or independently in the data store(s). In some examples, the historical data may include historical data associated with an entity, a publication, an IP asset, and/or a user account. For example, the historical data may include data specific to mergers and acquisitions associated with a particular entity and/or IP asset. The market data may include market data associated with an entity, an IP asset, a technological area, a product and/or service, and/or standardized market data, and/or any other non-IP related data of the like.

In some examples, a user interface generation component may be configured to generate user interface element(s) and/or user interface pages described above using data received from other components utilized by the system. In some examples, the user interface generation component may be communicatively coupled to the other components stored thereon the computer-readable media. In some examples, the user interface generation component may generate user interfaces configured to present information associated with analysis reports associated with a user account. Additionally, or alternatively, the user interface generation component may generate user interfaces including confidential information and may be configured to be accessible by only users with predetermined qualifications. For example, the user interface generation component may cause only a portion of information to be displayed based on the type of account that is accessing the system. For example, when a user accesses the system, the system may determine that the account type of the account that the user has utilized to access the system may be one of, for example, a client user account and/or an administrative user account. In some examples, the user interface generation component may generate interactive graphical elements and/or dynamic animation sequences associated with the interactive graphical elements.

Take for example, a user accessing the IP analysis platform to interact with, conduct research, and/or create a new analysis report. The scoring component may be configured to receive data representing an analysis report. Additionally, or alternatively, the scoring component may be configured to receive data representing a research query that is unassociated with an analysis. It should be appreciated that the operations described herein may be executed in association with and/or standalone from analysis reports. The analysis report may be created by and associated with a user account and/or one or more user accounts that are associated with the user account. The analysis reports may be stored in association with the user account data in the secure datastore. In some examples, the analysis reports may be utilized to organize and/or separate searches, identified similar IP assets and/or entities.

As mentioned above, the IP analysis platform may include a scoring component that includes sub-components, such as, a coverage component utilized to determine an overall coverage and/or identify gaps in coverage, an opportunity component utilized to determine a potential market opportunity, and an exposure component utilized to determine a potential exposure associated with the IP assets. In some examples, each of the coverage component, the opportunity component, and the exposure component may include one or more sub-components.

For example, the coverage component may include various sub-components, such as, a geographic distribution component, an expiration component, a comprehensive breadth score component, a diversity component, a revenue alignment component and/or an invalidity component. In some examples, the coverage component may utilize the one or more sub-components to make determinations and/or generate data to be displayed on the user interface. For example, each of the sub-components may generate a metric to be utilized by the coverage component to generate a coverage metric. In some examples, the coverage metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The coverage metric may indicate a comprehensive score indicating an IP coverage associated with the IP asset portfolio and/or a subset of the IP asset portfolio.

In some examples, the geographic distribution component may make determinations and/or generate data to be displayed on the user interface. For example, a user may specify one or more target entities, one or more target publications, and/or one or more target products that the geographic distribution component may utilize to generate a geographic distribution search. In some examples, the geographic distribution component may be configured to identify one or more target entities utilizing data representing one or more target publications and/or one or more target products. The results of the geographic distribution search may include an identification of which countries and/or regions that individual IP assets of an IP asset portfolio are filed. In some examples, the geographic distribution component may determine which countries and/or regions the IP assets of the IP asset portfolio are filed for a given entity, market, and/or technology area. In some cases, the geographic distribution component may determine a metric based at least in part on which countries the IP assets are filed. For example, the geographic distribution component may determine a gross domestic product (GDP) value associated with each country and/or region in which an entity has filed IP assets. The geographic distribution component may generate a metric based on which countries and/or regions the IP assets are filed and the GDP of those respective countries and/or regions. In some cases, if a country that the IP assets are filed in have a higher GDP, the geographic distribution component may generate a positive metric. Additionally, and/or alternatively, if a country that the IP assets are filed in have a lower GDP, the geographic distribution component may generate a negative metric. In some examples, the metrics generated by the geographic distribution component may be used by the coverage component to generate a coverage metric.

In some examples, the expiration component may make determinations and/or generate data to be displayed on the user interface. For example, a user may specify one or more target entities, one or more target publications, and/or one or more target products that the expiration component may utilize to generate an expiration search. In some examples, the expiration component may be configured to identify one or more target entities utilizing data representing one or more target publications and/or one or more target products. The results of the expiration search may include determining a number and/or a breadth score associated with individual IP assets of an asset portfolio. In some cases, the expiration component may determine that a number of IP assets of an asset portfolio are about to expire and that a breadth score of these IP assets are high. In this case, the expiration component may generate a negative metric to be provide to the coverage component. Additionally, and/or alternatively, the expiration component may determine that a number of IP assets of an asset portfolio are about to expire and that a breadth score of these IP assets are low. In this case, the expiration component may generate a less negative metric to be provide to the coverage component.

In some examples, the comprehensive breadth score component may make determinations and/or generate data to be displayed on the user interface. For example, a user may specify one or more target entities, one or more target publications, and/or one or more target products that the comprehensive breadth score component may utilize to generate a comprehensive breadth search. In some examples, the comprehensive breadth score component may be configured to identify one or more target entities utilizing data representing one or more target publications and/or one or more target products. The results of the comprehensive breadth search may include a comprehensive breadth score for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The comprehensive breadth score for a group of IP assets (e.g., a portfolio of IP assets and/or a sub-set of the portfolio of IP assets) may be based on weighted breadth scores calculated for individual IP assets of the group of IP assets. For example, the comprehensive breadth score component may receive or otherwise identify a plurality of IP assets associated with an entity and calculate, for the individual IP assets of the plurality of IP assets, a breadth score based at least in part on a word count score and a commonness score for the respective portions of text included in the individual intellectual-property assets. In some cases, the word count score may be based on a word count associated with respective portions of text and word counts associated with portions of text from at least one other IP asset of the plurality of IP assets. In some cases, the commonness score may be based on a frequency in which words within the respective portion of text are found in the portions of text from at least one other IP asset. Once the breadth score is calculated for individual IP assets of the group of IP assets, the comprehensive breadth score component may calculate a weighted score for the individual IP assets based on multiplying the breadth score by a weight that is determined by the respective breadth scores for the individual IP assets. For example, the comprehensive breadth score component may assign a lower weight (e.g., 1) to an IP asset determined to have a low breadth score, a medium weight (e.g., 2) to an IP asset determined to have a medium breadth score, and a higher weight (e.g., 3) to an IP asset determined to have a high breadth score. Once the weighted breadth scores are determined, the comprehensive breadth score component may calculate a comprehensive score for the group of IP assets by calculating an average of the weighted scores of the individual IP assets. In some examples, the comprehensive breadth score component may provide the comprehensive score for the group of IP assets to the coverage component to be used in calculating a coverage metric.

In some cases, the comprehensive breadth score component can calculate the comprehensive breadth score for a group of IP assets based on a market and/or technology area. In some examples, the comprehensive breadth score component can calculate the comprehensive breadth score over multiple periods of time such that a visualization of how the comprehensive breadth score for a group of IP assets has changed over time can be depicted. In some cases, the comprehensive breadth score for a group of IP assets may have changed due to a new IP asset that has been filed, a new IP asset that has granted, an IP asset that has expired, a and IP asset that has been abandoned and/or a breadth score for an IP asset that has changed.

In some examples, the diversity component may make determinations and/or generate data to be displayed on the user interface. For example, a user may specify one or more target entities, one or more target publications, and/or one or more target products that the diversity component may utilize to generate a diversity search. In some examples, the diversity component may be configured to identify one or more target entities utilizing data representing one or more target publications and/or one or more target products. The results of the diversity search may include a metric indicating how diversified a group of IP assets are over a given market and/or technology area.

In some examples, the revenue alignment component may make determinations and/or generate data to be displayed on the user interface. For example, a user may specify one or more target entities, one or more target publications, and/or one or more target products that the revenue alignment component may utilize to generate a revenue alignment search. In some examples, the revenue alignment component may be configured to identify one or more target entities utilizing data representing one or more target publications and/or one or more target products. The results of the revenue alignment search may include a metric indicating how a group of IP assets associated with an entity and with a given market and/or technology area aligns with the revenue generated by that market and/or technology area for the entity. For example, the revenue alignment component may identify one or more market areas and/or technology areas associated with an entity accessing the IP analysis platform. The revenue alignment component may identify revenue streams of the entity that are associate with the one or more market areas and/or one or more technology areas and identify a number of IP assets that are associated with the entity as well as the one or more technology areas. In some cases, the revenue alignment component may determine a percentage of revenue generated in a market area and/or technology area of a total amount of revenue generated by the entity and may determine a percentage of IP assets directed to the one or more market areas and/or one or more technology areas from among a group of IP assets filed by the entity. The revenue alignment component may then generate an alignment metric based at least in part on the number of the IP assets associated with the one or more market areas and/or one or more technology areas and the one or more revenue streams associated with the one or more market areas and/or one or more technology areas. In some examples, the revenue alignment component may identify the market and/or technology areas by accessing a taxonomy of market sets and/or a taxonomy of technology areas provided by a third-party resource and/or stored on the database. In this way, the revenue alignment component may illustrate if an entity is revenue heavy (e.g., greater percentage of revenue generated than percentage of IP assets filed) or is more IP asset heavy (e.g., greater percentage of IP assets filed than percentage of revenue generated) for individual market areas and/or technology areas.

In some cases, the revenue alignment component may also generate a metric illustrating a revenue alignment for multiple other entities. For example, the revenue alignment component may determine a percentage of revenue generated in a market area and/or technology area of a total amount of revenue generated by a group of entities and may determine a percentage of IP assets directed to the one or more market areas and/or one or more technology areas from among a group of IP assets filed by the group of entities. In this way, the revenue alignment component may illustrate a comparison of a revenue alignment metric associated with the entity to a revenue alignment metric associated with multiple other entities generating revenue and filing IP assets in an individual market area and/or technology area.

In some examples, the invalidity component may make determinations and/or generate data to be displayed on the user interface. For example, a user may specify one or more target entities, one or more target publications, and/or one or more target products that the invalidity component may utilize to generate a geographic distribution search. In some examples, the invalidity component may be configured to identify one or more target entities utilizing data representing one or more target publications and/or one or more target products. The results of the invalidity search may include citation data associated with a group of IP assets and/or individual IP assets associated with an entity accessing the IP analysis platform. In some cases, the invalidity component may generate an invalidity metric indicating a likelihood that an IP asset may be considered to be invalid if it were to be challenged in a court of law: In some cases, the invalidity component may generate the invalidity metric based on a density of other IP assets cited during prosecution of the IP asset, a density of other IP assets in which the IP asset was cited during prosecution, and/or litigation data associated with the other IP assets (e.g., result of invalidity challenges of the other IP assets). In some cases, the invalidity metric may be utilized by other component and/or sub-components to impact other metrics, such as the comprehensive breadth score metric.

In some cases, the coverage component may utilize any metric generated by the various sub-components to generate a coverage metric associated with a group of IP assets associated with an entity and/or other entities. In some cases, other determinations may affect the coverage metric, such as, legal status of an IP asset (e.g., ownership of the IP asset), how a breadth scope of claims change during prosecution of an IP asset, etc.

In some cases, the opportunity component may include various sub-components, such as, a filing velocity component, a predictive analytics component, a precedence component, and/or an innovation metric component. In some examples, the opportunity component may utilize the one or more sub-components to make determinations and/or generate data to be displayed on the user interface. For example, each of the sub-components may generate a metric to be utilized by the opportunity component to generate an opportunity metric. In some examples, the opportunity metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The opportunity metric may indicate a potential market area and/or technology area opportunity associated with the IP asset portfolio and/or a subset of the IP asset portfolio.

In some examples, the filing velocity component may make determinations and/or generate data to be displayed on the user interface. For example, a user may specify one or more target entities, one or more target publications, and/or one or more target products that the filing velocity component may utilize to generate a filing velocity search. In some examples, the filing velocity component may be configured to identify one or more target entities utilizing data representing one or more target publications and/or one or more target products. The results of the filing velocity search may include a filing velocity metric indicating a percentile rank of an entity for filing of IP assets in a given market area and/or technology area. For example, the filing velocity component may identify a total amount of IP assets filed that are directed towards or otherwise associated with a given market area and/or technology area for a period of time (e.g., a year, five years, ten years, etc.) The filing velocity component may then identify a number of IP assets filed by individual entities, such as an entity accessing the IP analysis platform and associated entity competitors, during that time period directed towards or otherwise associated with the market area and/or the technology area. In some examples, the filing velocity component may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component to generate an opportunity metric. For example, a low percentile ranking (e.g., 10%, 20%, 30%) may indicate that an entity is underperforming with regard to a number of IP assets filed in a particular market area and/or technology area. Additionally, and/or alternatively, a high percentile ranking (e.g., 70%, 80%, 90%) may indicate that an entity is overperforming with regard to a number of IP assets filed in a particular market area and/or technology area.

In some examples, the filing velocity component may identify a total amount of IP assets filed that are directed towards or otherwise associated with an IP art unit for a period of time (e.g., a year, five years, ten years, etc.) The filing velocity component may then identify a number of IP assets filed by individual entities, such as an entity accessing the IP analysis platform and associated entity competitors, during that time period directed towards or otherwise associated with the IP art unit. In some examples, the filing velocity component may then generate a percentile ranking for each entity based at least in part on comparing the number of IP assets filed by the individual entities during the time period to the total number of IP assets filed during the time period. In some examples, the percentile ranking of each entity maybe utilized as a metric for the opportunity component to generate an opportunity metric. For example, a low percentile ranking (e.g., 10%, 20%, 30%) may indicate that an entity is underperforming with regard to a number of IP assets filed in a particular IP art unit. Additionally, and/or alternatively, a high percentile ranking (e.g., 70%, 80%, 90%) may indicate that an entity is overperforming with regard to a number of IP assets filed in a particular IP art unit.

In some examples, the predictive analytics component may make determinations and/or generate data to be displayed on the user interface. For example, a user may specify one or more target entities, one or more target publications, and/or one or more target products that the predictive analytics component may utilize to generate a predictive analytics search. In some examples, the predictive analytics component may be configured to identify one or more target entities utilizing data representing one or more target publications and/or one or more target products. The results of the predictive analytics search may include a predicted comprehensive breadth score for a pending IP asset associated with an entity. For example, the predictive analytics component may determine an examiner and/or an art unit associated with at least one pending IP asset filed or otherwise associated with the entity. In some cases, the predictive analytics component may determine a comprehensive breadth score, as discussed herein, for at least one originally filed claim of an IP asset (e.g., application) previously examined by the examiner and/or previously filed in the art unit. The predictive analytics component may then determine a comprehensive breadth score for an issued version of the originally filed claim of the application and generate an examiner metric and/or an art unit metric based at least in part on a difference between the comprehensive breadth score of the originally filed claims and the comprehensive breadth score of the issued claims. In this way, the predictive analytics component may determine an effect that a particular examiner and/or art unit may have on a comprehensive breadth score of a potentially allowable claim. For example, the predictive analytics component may determine predicted breadth score for a pending IP asset based at least in part on the examiner metric and/or the art unit metric. In some cases, the predicted breadth score may be utilized by the opportunity component to generate the opportunity metric.

In some cases, the predictive analytics component may generate a predicted issue date for a pending IP asset associated with an entity based on an average length of prosecution associated with an examiner and/or an art unit. In some cases, the predicted issue date may be utilized by the opportunity component to generate the opportunity metric.

In some examples, the precedence component may make determinations and/or generate data to be displayed on the user interface. For example, a user may specify one or more target entities, one or more target publications, and/or one or more target products that the precedence component may utilize to generate a precedence search. In some examples, the precedence component may be configured to identify one or more target entities utilizing data representing one or more target publications and/or one or more target products. The results of the precedence search may include metric data indicating a historical precedence associated with an IP asset. For example, the precedence component may identify a particular market area and/or technology area associated with an IP asset and determine a number of similar IP assets filed within the identified market area and/or technology area. In some examples, if the number of other IP assets is low; then the precedence metric associated with the IP asset may be high. Additionally, and/or alternatively, if the number of other IP assets is high, then the precedence metric associated with the IP asset may be low: Once the precedence component determines a precedence metric, the precedence metric may be provided to the opportunity component and utilized to generate the opportunity metric.

In some examples, the innovation metric component may make determinations and/or generate data to be displayed on the user interface. For example, a user may specify one or more target entities, one or more target publications, one or more target markets, one or more target technology areas, and/or one or more target products that the innovation metric component may utilize to generate an innovation metric. In some cases, the innovation metric may provide an indication that an entity, a technology area, and/or a market is associated with architectural innovation, incremental innovation, radical innovation, and/or disruptive innovation. In some case, the innovation metric may be obtained by calculating (e.g., by the IP analysis platform) an amount of time since an average filing date of IP assets in a grouping over a fixed time period. In some cases, a more recent average filing date may be a proxy for a better innovation metric. By way of example, the innovation metric component may identify an entity, a technology space, and/or a market associated with IP assets and determine a respective filing date associated with each IP asset between a first date and a second date. For example, the innovation metric component may access a data store containing an IP asset library to obtain information associated with each of the IP assets. In some case, the innovation metric component may determine an average filing date associated with the IP assets filed between the first date and the second date and determine an amount of time between the average filing date and the second date. For example, the IP assets associated with the entity, the technology space, and/or the market may have an average filing date between a 10-year period (e.g., between the year 2000 and the year 2010) of Dec. 31, 2007. In this example, the first date being Jan. 1, 2000, and the second date being Dec. 31, 2010, the amount of time between the average filing date and the second date would be 3-years. In some cases, the innovation metric component may generate a score associated with the entity, the technology space, and/or the market based on the amount of time. For example, a more recent average filing date would equate to a shorter period of time between the average filing date and the second date and thus, be a proxy for a better innovation metric.

In some cases, the innovation metric component may be configured to determine additional metrics associated with the innovation metric. For example, the innovation metric component may determine a normalized innovation metric and/or a percentile innovation metric. For example, regarding the normalized innovation metric, across a given group of IP assets, the innovation metric may be normally distributed. The innovation metric component may configure the innovation metric to reflect a position of a particular innovation metric by its distance from a mean in standard deviation units. Thus, if an entities, technology spaces, and/or markets innovation metric is equal to a mean innovation metric from a group of innovation metrics of similar entities, technology spaces, and/or markets, then that normalized innovation metric is zero. If an entities, technology spaces, and/or markets innovation metric is one standard deviation from the mean, then its normalized innovation metric will be 1 or −1 depending on if it is greater or less than the mean innovation metric. In some cases, regarding the percentile innovation metric, the innovation metric component may set a lowest innovation metric from a group of innovation metrics to zero and the highest innovation metric to 100 and order all the innovation metrics in between according to the percentile that they fall into. In this case, each innovation metric may be associated with a particular entity, technology space, and/or market deemed to be similar by the IP analysis system. The percentile framework provides a way to directly compare entities, technology spaces, and/or markets with each other by comparing the magnitude of their percentile score (e.g., 100 being the highest percentile innovation metric and 0 being the lowest percentile innovation metric).

In some examples, the exposure component may include various sub-component, such as, a litigation campaign component and/or an alignment to exposure component. In some examples, the exposure component may utilize the one or more sub-components to make determinations and/or generate data to be displayed on the user interface. For example, each of the sub-components may generate a metric to be utilized by the exposure component to generate an exposure metric. In some examples, the exposure metric may be generated for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The exposure metric may indicate a potential exposure and/or risk (e.g. potential risk of litigation) associated with a market area and/or technology area associated with the IP asset portfolio and/or a subset of the IP asset portfolio. In some examples, the exposure component may identify the levels of exposure associated with the result sets and/or IP assists associated with an entity, and may aggregate the data indicating the levels of exposure associated with the result sets and/or IP asset to determine an overall level of exposure for an entity. In some examples, the exposure assessment component may be utilized in combination with any of the components described above. Additionally, or alternatively, the exposure component may make determinations and/or generate data to be displayed on the user interface.

In some examples, the litigation campaign component may make determinations and/or generate data to be displayed on the user interface. For example, a user may specify one or more target entities, one or more target publications, and/or one or more target products that the litigation campaign component may utilize to generate a litigation campaign search. In some examples, the litigation campaign component may be configured to identify one or more target entities utilizing data representing one or more target publications and/or one or more target products. The results of the litigation campaign search may include data indicating a potential likelihood of litigation associated with a particular market area and/or technology area. For example, the litigation campaign component may identify a litigation campaign associated with a market area and/or technology area by determining that an entity has filed at least two cases associated with the market area and/or technology area within the same calendar year. Once the litigation campaign component determines that the at least two cases are part of a litigation campaign directed towards a particular market area and/or technology area, the litigation campaign component may determine a period of time since the most recent filing of a case included in the litigation campaign, a number of defendants associated with the litigation campaign, and/or a non-practicing entity (NPE) status of the litigation campaign (e.g., whether the entity associated with the litigation campaign is an NPE or a practicing entity). In some examples, the litigation campaign component may obtain litigation data (e.g., defendant information, plaintiff information, case filing information, etc.) from a third party resource and may store the data in the database. In some cases, the data generated by the litigation campaign component may be provided to the exposure component and utilized to generate an exposure metric.

In some examples, the alignment to exposure component may make determinations and/or generate data to be displayed on the user interface. For example, a user may specify one or more target entities, one or more target publications, and/or one or more target products that the alignment to exposure component may utilize to generate an alignment to exposure search. In some examples, the alignment to exposure component may be configured to identify one or more target entities utilizing data representing one or more target publications and/or one or more target products. The results of the alignment to exposure search may include metric data indicating a potential exposure metric associate with a group of IP assets associated with an entity with regard to potential litigation. For example, the alignment to exposure component may determine a market area and/or technology area associated with a group of IP assets filed and/or otherwise associated with an entity, such as an entity utilizing the IP analysis platform. The alignment to exposure component may then identifying a litigation history (e.g., past litigation and current litigation) associated with the technology area and/or market area. In some cases, if there is a large amount of litigation associated with the market area and/or technology area, the alignment to exposure component may determine that the group of IP assets are at a greater risk of litigation. Additionally, and/or alternatively, if there is a small amount of litigation associated with the market area and/or technology area, the alignment to exposure component may determine that the group of IP assets are at a lesser risk of litigation. In some cases, the data generated by the alignment to exposure component may be provided to the exposure component and utilized to generate an exposure metric.

In some examples, the scoring component may utilize the coverage component, the opportunity component, the exposure component, and the respective metrics associated with each component to generate an overall score for a group of IP assets associated with an entity. The overall score may indicate i) an overall coverage and/or identify gaps in coverage: ii) a potential market opportunity; and/or iii) a potential exposure associated with the IP assets. included in the targeted technical fields, subject matters, and/or competitor entities portfolios.

In some examples, the scoring component may be configured to receive data representing a seeded search query and may perform a search operation in a number of ways and provide data and/or metrics to the various other components and sub-components discussed herein. A seeded search query may include one or more instances of target data as described in more detail below. In some examples, the seeded search query may indicate an identification of one or more target entities. Additionally, or alternatively, the seeded search query may indicate an identification of one or more target publications, such as, for example, an IP asset. Additionally, or alternatively, the seeded search query may indicate an identification of one or more target products and/or services. In some examples, the IP analysis platform may be configured to receive additional data associated with the seeded search query. For example, the scoring component may be configured to receive additional data via one or more actionable elements included on a graphical user interface (GUI) presented on a computing device and accessible to a user account. Additionally, or alternatively, the scoring component may be configured to utilize the data representing a seeded search query to make various identifications and determinations associated with IP assets and/or entities, among other things.

In some examples, the seeded search query may indicate the identification of the one or more target entities, and the scoring component may utilize the data to identify IP assets that are associated with the target entity. In some examples, the scoring component may access one or more database(s) including a listing of all of the available IP assets associated with the target entity (e.g., an IP asset portfolio). Additionally, or alternatively, the scoring component may generate a result set including IP assets having an assignee associated with the entity.

Additionally, or alternatively, the seeded search query may indicate the identification of the one or more target publications may utilize the data representing the seeded search query to identify IP assets (or IP asset portfolios) that are determined to be similar to the target publication. The scoring component may identify similar IP assets using various techniques. For example, the scoring component may generate a vector representation of the target publication and use the vector representation to identify IP assets having similar vector representations. Techniques to generate vectors representing IP assets may include vectorization techniques such as Doc2Vec, or other similar techniques. Additionally, or alternatively, techniques to generate vectors representing IP assets may include a method that takes a document, such as an IP asset, and turns it into a vector form as a list of floating-point numbers based at least in part on the document's text contents. This vector form may be called an embedding. This embedding may be used to calculate distance, and therefore similarity, between documents.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

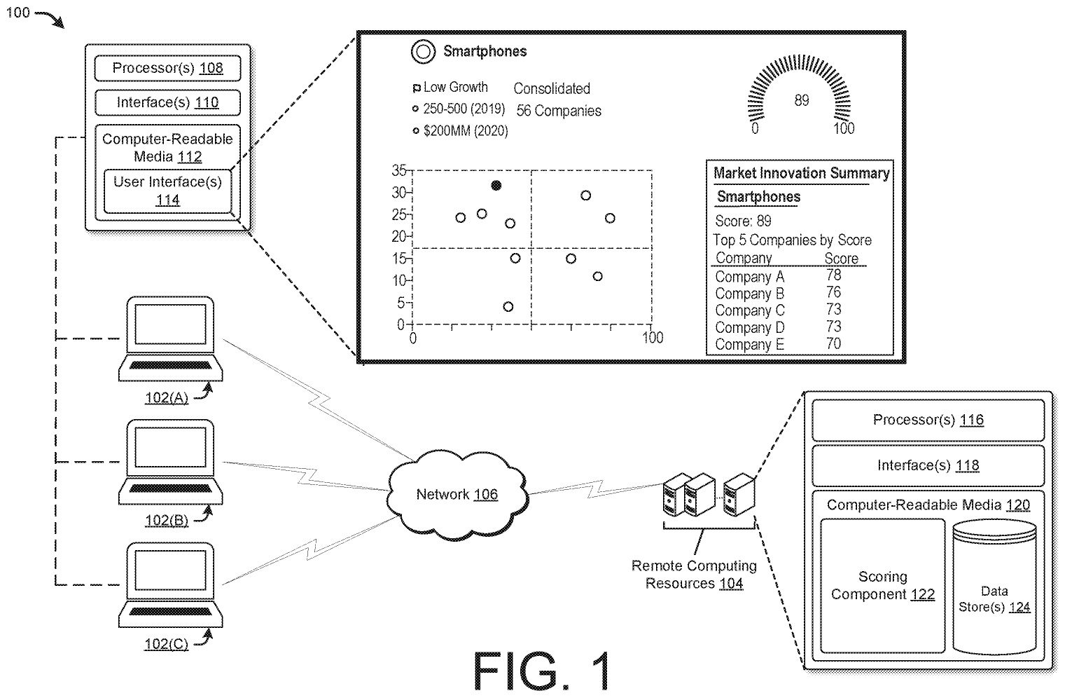

FIG. 1 illustrates a schematic diagram of an example environment 100 for an IP analysis platform architecture. The architecture 100 may include, for example, one or more user devices 102(a)-(c), also described herein as electronic devices 102(a)-(c), and/or a remote computing resources 104 associated with the IP analysis platform. Some or all of the devices and systems may be configured to communicate with each other via a network 106.

The electronic devices 102 may include components such as, for example, one or more processors 108, one or more network interfaces 110, and/or computer-readable media 112. The computer-readable media 112 may include components such as, for example, one or more user interfaces 114. As shown in FIG. 1, the electronic devices 102 may include, for example, a computing device, a mobile phone, a tablet, a laptop, and/or one or more servers. The components of the electronic device 102 will be described below by way of example. It should be understood that the example provided herein is illustrative and should not be considered the exclusive example of the components of the electronic device 102.

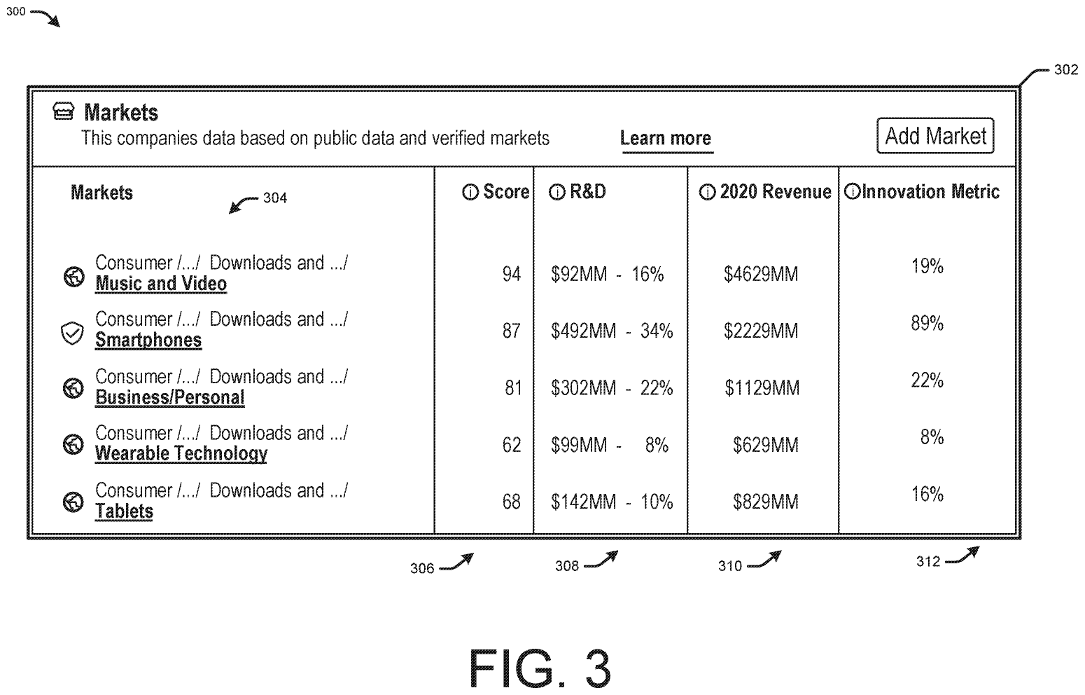

By way of example, the user interface(s) 114 may include one or more of the user interfaces described elsewhere herein, such as the user interfaces described with respect to FIGS. 3-5, corresponding to a comprehensive score user interface, market analysis user interface, an innovation metric interface, etc. It should be understood that while the user interface(s) 114 are depicted as being a component of the computer-readable media 112 of the electronic devices 102(a)-(c), the user interface(s) 114 may additionally or alternatively be associated with the remote computing resources 104. The user interface(s) 114 may be configured to display information associated with the IP analysis platform and to receive user input associated with the IP analysis platform.

The remote computing resources 104 may include one or more components such as, for example, one or more processors 116, one or more network interfaces 118, and/or computer-readable media 120. The computer-readable media 120 may include one or more components, such as, for example, a scoring component 122 and/or one or more data store(s) 124. The scoring component 122 may be configured to receive user input data as described herein for indicating target data representing at least one of an entity, publication, a technology space, a market, and/or product utilized to generate seeded search queries that utilize the target data to determine a representative entity, market, technology space, and/or product and return results including IP assets associated with the representative entity, market, technology space, and/or product and/or one or more entries, markets, technology spaces, and/or products that have IP assets that are determined to be similar to the IP assets of the representative entity, market, technology space, and/or product. The scoring component 122 may also be configured to generate vector representations of the entities and/or IP assets such that the scoring component 122 may rank and/or otherwise analyze the results from the search query by utilizing vector representations. The scoring component 122 may also be configured to utilize the vector representations of the entity, market, technology space, and/or product and/or the IP assets associated with the entity, market, technology space, and/or product to generate result sets including comprehensive breadth scores, revenue alignment metrics, IP asset filing metrics, innovation metrics and/or litigation campaign metrics associated with the technical fields, products or technologies of interest, IP assets associated with particular market areas and/or technical areas, etc. The scoring component 122 may also be configured to generate an interactive graphical element, that may be configured to respond to various user inputs representing manipulations to the interactive graphical element, for presenting a spatial representation of the one or more metrics included in a selected result set.

The data store(s) 124 of the remote computing resources 104 may include data corresponding to user accounts, analysis reports, historical data, and/or intellectual-property assets The analysis reports may include, for example, seeded search queries, similar entity and/or publication results, metric results, and/or the spatial representation of the metric results.

The analysis reports may be stored with respect to the user account of the data store 124. The IP assets may be stored with respect to an IP asset library of the data store 124.

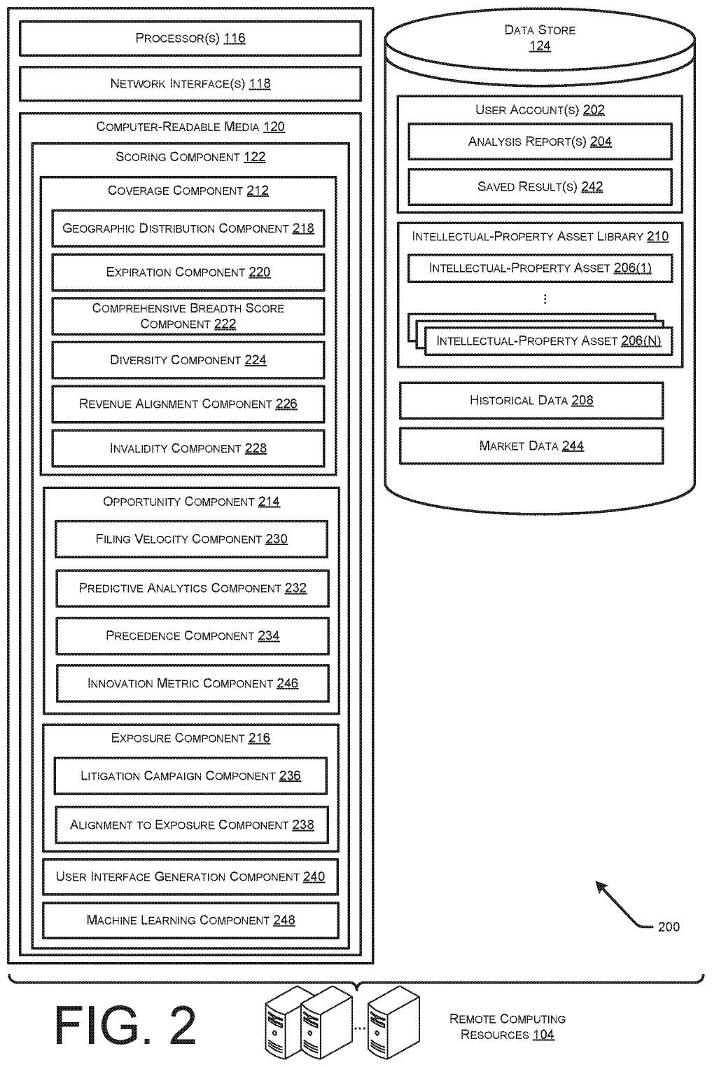

As shown in FIG. 2, several of the components of the remote computing resources 104 and/or the electronic devices 102 and the associated functionality of those components as described herein may be performed by one or more of the other systems and/or by the electronic devices 102. Additionally, or alternatively, some or all of the components and/or functionalities associated with the electronic devices 102 may be performed by the remote computing resource(s) 104.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 108 and/or 116, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 108 and/or 116 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 108 and/or 116 may possess its own local memory, which also may store program components, program data, and/or one or more operating systems.

The computer-readable media 112 and/or 120 may include volatile and nonvolatile memory, removable and non-removable media implemented in any method or technology for storage of information, such as computer-readable instructions, data structures, program component, or other data. Such computer-readable media 112 and/or 120 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 112 and/or 120 may be implemented as computer-readable storage media (“CRSM”), which may be any available physical media accessible by the processor(s) 108 and/or 116 to execute instructions stored on the computer-readable media 112 and/or 120. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as computer-readable media 112 and/or 120, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project: other UNIX or UNIX-like variants: a variation of the Linux operating system as promulgated by Linus Torvalds: the FireOS operating system from Amazon.com Inc. of Seattle, Washington, USA: the Windows operating system from Microsoft Corporation of Redmond, Washington, USA: LynxOS as promulgated by Lynx Software Technologies, Inc. of San Jose, California: Operating System Embedded (Enea OSE) as promulgated by ENEA AB of Sweden; and so forth.

The network interface(s) 110 and/or 118 may enable messages between the components and/or devices shown in architecture 100 and/or with one or more other remote systems, as well as other networked devices. Such network interface(s) 110 and/or 118 may include one or more network interface controllers (NICs) or other types of transceiver devices to send and receive messages over the network 106.

For instance, each of the network interface(s) 110 and/or 118 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 110 and/or 118 may include a wide area network (WAN) component to enable message over a wide area network.

In some instances, the remote computing resources 104 may be local to an environment associated with the electronic device(s) 102. For instance, the remote computing resources 104 may be located within the electronic device(s) 102. In some instances, some or all of the functionality of the remote computing resources 104 may be performed by the electronic device(s) 102. Also, while various components of the remote computing resources 104 have been labeled and named in this disclosure and each component has been described as being configured to cause the processor(s) 108 and/or 116 to perform certain operations, it should be understood that the described operations may be performed by some or all of the components and/or other components not specifically illustrated.

FIG. 2 illustrates a component diagram of example components 200 of a remote computing resource 104 for the vendor management platform. The remote computing resource 104 may include one or more components such as, for example, one or more processor(s) 116, one or more network interfaces 118, and/or computer-readable media 120. The computer-readable media may include one or more components, such as, for example, a scoring component 122 and/or one or more data stores 124. Some or all of the components and functionalities may be configured to communicate with each other.

The data store(s) 124 may include data corresponding to user account(s) 202, analysis report(s) 204, intellectual-property (IP) asset(s) 206(1)-(N), historical data 208, saved result(s) 242 from previous interactions the user account has made with the IP analysis platform, and/or market data 244. The analysis report(s) 204 may include, for example, seeded search queries, similarity results, metric results, and/or spatial representations of metrics. The analysis report(s) 204 may be stored with respect to the user account(s) 202. Additionally, or alternatively, the saved result(s) 242 may include, for example, seeded search queries, similarity results, metric results, and/or spatial representations of metric. The IP asset(s) 206(1)-(N) may be stored with respect to an IP asset library 210. In some examples, the IP asset library 210 may include data associated with IP assets and/or related to a corresponding IP asset, such as, for example, licensing data, and/or standard essential patent data. The historical data 208 may be stored with respect to the user account(s) 202 and/or independently in the data store(s) 124. In some examples, the historical data 208 may include historical data associated with an entity, a publication, an IP asset 206, and/or a user account 202. For example, the historical data 208 may include data specific to mergers and acquisitions associated with a particular entity and/or IP asset 206. The market data 244 may include market data associated with an entity, an IP asset 206, a technological area, a product and/or service, standardized market data, revenue data, and/or any other non-IP related data of the like. In some examples, the market data 244 may be obtained from a third-party resource.

As mentioned with respect to FIG. 1, the scoring component 122 may be configured to receive user input data as described herein for indicating target data representing at least one of an entity, publication, a technology space, a market, and/or product utilized to generate seeded search queries that utilize the target data to determine a representative entity, market, technology space, and/or product and return results including IP assets associated with the representative entity, market, technology space, and/or product and/or one or more entries, markets, technology spaces, and/or products that have IP assets that are determined to be similar to the IP assets of the representative entity, market, technology space, and/or product. The scoring component 122 may also be configured to generate vector representations of the entities and/or IP assets such that the scoring component 122 may rank and/or otherwise analyze the results from the search query by utilizing vector representations. The scoring component 122 may also be configured to utilize the vector representations of the entity, market, technology space, and/or product and/or the IP assets associated with the entity, market, technology space, and/or product to generate result sets including comprehensive breadth scores, revenue alignment metrics, IP asset filing metrics, innovation metrics and/or litigation campaign metrics associated with the technical fields, products or technologies of interest. IP assets associated with particular market areas and/or technical areas, etc. The scoring component 122 may also be configured to generate an interactive graphical element, that may be configured to respond to various user inputs representing manipulations to the interactive graphical element, for presenting a spatial representation of the one or more metrics included in a selected result set. The scoring component 122 may include one or more components, such as, a coverage component 212 utilized to determine an overall coverage and/or identify gaps in coverage, an opportunity component 214 utilized to determine a potential market opportunity, and an exposure component 216 utilized to determine a potential exposure associated with the IP assets. In some examples, each of the coverage component 212, the opportunity component 214, and the exposure component 216 may include one or more sub-components.

For example, the coverage component 212 may include various sub-components, such as, a geographic distribution component 218, an expiration component 220, a comprehensive breadth score component 222, a diversity component 224, a revenue alignment component 226 and/or an invalidity component 228. In some examples, the coverage component 212 may utilize the one or more sub-components to make determinations and/or generate data to be displayed on the user interface. For example, each of the sub-components may generate a metric to be utilized by the coverage component 212 to generate a coverage metric. In some cases, the opportunity component 214 may include various sub-components, such as, a filing velocity component 230, a predictive analytics component 232, a precedence component 234, and an innovation metric component 246. In some examples, the opportunity component 214 may utilize the one or more sub-components to make determinations and/or generate data to be displayed on the user interface. For example, each of the sub-components may generate a metric to be utilized by the opportunity component 214 to generate an opportunity metric. In some examples, the exposure component 216 may include various sub-component, such as, a litigation campaign component 236 and/or an alignment to exposure component 238. In some examples, the exposure component 216 may utilize the one or more sub-components to make determinations and/or generate data to be displayed on the user interface. For example, each of the sub-components may generate a metric to be utilized by the exposure component 216 to generate an exposure metric. Additionally, or alternatively, the scoring component 122 may be configured to perform the operations described below with respect to the one or more components.

In some examples, the geographic distribution component 218 may make determinations and/or generate data to be displayed on the user interface. For example, a user may specify one or more target entities, one or more target publications, and/or one or more target products that the geographic distribution component 218 may utilize to generate a geographic distribution search. In some examples, the geographic distribution component 218 may be configured to identify one or more target entities utilizing data representing one or more target publications and/or one or more target products. The results of the geographic distribution search may include an identification of which countries and/or regions that individual IP assets of an IP asset portfolio are filed. In some examples, the geographic distribution component 218 may determine which countries and/or regions the IP assets of the IP asset portfolio are filed for a given entity, market, and/or technology area. In some cases, the geographic distribution component 218 may determine a metric based at least in part on which countries the IP assets are filed. For example, the geographic distribution component 218 may determine a gross domestic product (GDP) value associated with each country and/or region in which an entity has filed IP assets. The geographic distribution component 218 may generate a metric based on which countries and/or regions the IP assets are filed and the GDP of those respective countries and/or regions. In some cases, if a country that the IP assets are filed in have a higher GDP, the geographic distribution component 218 may generate a positive metric. Additionally, and/or alternatively, if a country that the IP assets are filed in have a lower GDP, the geographic distribution component 218 may generate a negative metric. In some examples, the metrics generated by the geographic distribution component 218 may be used by the coverage component 212 to generate a coverage metric.

In some examples, the expiration component 220 may make determinations and/or generate data to be displayed on the user interface. For example, a user may specify one or more target entities, one or more target publications, and/or one or more target products that the expiration component 220 may utilize to generate an expiration search. In some examples, the expiration component 220 may be configured to identify one or more target entities utilizing data representing one or more target publications and/or one or more target products. The results of the expiration search may include determining a number and/or a breadth score associated with individual IP assets of an asset portfolio. In some cases, the expiration component 220 may determine that a number of IP assets of an asset portfolio are about to expire and that a breadth score of these IP assets are high. In this case, the expiration component 220 may generate a negative metric to be provide to the coverage component 212. Additionally, and/or alternatively, the expiration component 220 may determine that a number of IP assets of an asset portfolio are about to expire and that a breadth score of these IP assets are low: In this case, the expiration component 220 may generate a less negative metric to be provide to the coverage component 212.

In some examples, the comprehensive breadth score component 222 may make determinations and/or generate data to be displayed on the user interface. For example, a user may specify one or more target entities, one or more target publications, and/or one or more target products that the comprehensive breadth score component 222 may utilize to generate a comprehensive breadth search. In some examples, the comprehensive breadth score component 222 may be configured to identify one or more target entities utilizing data representing one or more target publications and/or one or more target products. The results of the comprehensive breadth search may include a comprehensive breadth score for an IP asset portfolio of an entity accessing the IP analysis platform, a sub-set of the IP asset portfolio (e.g., for a particular market and/or technology), an IP asset portfolio of another entity (e.g., business competitor) associated with the entity accessing the IP analysis platform, and/or a sub-set of the IP asset portfolio (e.g., for a particular market and/or technology) of the other entity. The comprehensive breadth score for a group of IP assets (e.g., a portfolio of IP assets and/or a sub-set of the portfolio of IP assets) may be based on weighted breadth scores calculated for individual IP assets of the group of IP assets. For example, the comprehensive breadth score component 222 may receive or otherwise identify a plurality of IP assets associated with an entity and calculate, for the individual IP assets of the plurality of IP assets, a breadth score based at least in part on a word count score and a commonness score for the respective portions of text included in the individual intellectual-property assets. In some cases, the word count score may be based on a word count associated with respective portions of text and word counts associated with portions of text from at least one other IP asset of the plurality of IP assets. In some cases, the commonness score may be based on a frequency in which words within the respective portion of text are found in the portions of text from at least one other IP asset. Once the breadth score is calculated for individual IP assets of the group of IP assets, the comprehensive breadth score component 222 may calculate a weighted score for the individual IP assets based on multiplying the breadth score by a weight that is determined by the respective breadth scores for the individual IP assets. For example, the comprehensive breadth score component 222 may assign a lower weight (e.g., 1) to an IP asset determined to have a low breadth score, a medium weight (e.g., 2) to an IP asset determined to have a medium breadth score, and a higher weight (e.g., 3) to an IP asset determined to have a high breadth score. Once the weighted breadth scores are determined, the comprehensive breadth score component 222 may calculate a comprehensive score for the group of IP assets by calculating an average of the weighted scores of the individual IP assets. In some examples, the comprehensive breadth score component 222 may provide the comprehensive score for the group of IP assets to the coverage component 212 to be used in calculating a coverage metric.

In some cases, the comprehensive breadth score component 222 can calculate the comprehensive breadth score for a group of IP assets based on a market and/or technology area. In some examples, the comprehensive breadth score component 222 can calculate the comprehensive breadth score over multiple periods of time such that a visualization of how the comprehensive breadth score for a group of IP assets has changed over time can be depicted. In some cases, the comprehensive breadth score for a group of IP assets may have changed due to a new IP asset that has been filed, a new IP asset that has granted, a, IP asset that has expired, a and IP asset that has been abandoned and/or a breadth score for an IP asset that has changed.

In some examples, the diversity component 224 may make determinations and/or generate data to be displayed on the user interface. For example, a user may specify one or more target entities, one or more target publications, and/or one or more target products that the diversity component 224 may utilize to generate a diversity search. In some examples, the diversity component 224 may be configured to identify one or more target entities utilizing data representing one or more target publications and/or one or more target products. The results of the diversity search may include a metric indicating how diversified a group of IP assets are over a given market and/or technology area.

In some examples, the revenue alignment component 226 may make determinations and/or generate data to be displayed on the user interface. For example, a user may specify one or more target entities, one or more target publications, and/or one or more target products that the revenue alignment component 226 may utilize to generate a revenue alignment search. In some examples, the revenue alignment component 226 may be configured to identify one or more target entities utilizing data representing one or more target publications and/or one or more target products. The results of the revenue alignment search may include a metric indicating how a group of IP assets associated with an entity and with a given market and/or technology area aligns with the revenue generated by that market and/or technology area for the entity. For example, the revenue alignment component 226 may identify one or more market areas and/or technology areas associated with an entity accessing the IP analysis platform. The revenue alignment component 226 may identify revenue streams of the entity that are associate with the one or more market areas and/or one or more technology areas and identify a number of IP assets that are associated with the entity as well as the one or more technology areas. In some cases, the revenue alignment component 226 may determine a percentage of revenue generated in a market area and/or technology area of a total amount of revenue generated by the entity and may determine a percentage of IP assets directed to the one or more market areas and/or one or more technology areas from among a group of IP assets filed by the entity. The revenue alignment component 226 may then generate an alignment metric based at least in part on the number of the IP assets associated with the one or more market areas and/or one or more technology areas and the one or more revenue streams associated with the one or more market areas and/or one or more technology areas. In some examples, the revenue alignment component 226 may identify the market and/or technology areas by accessing a taxonomy of market sets and/or a taxonomy of technology areas provided by a third-party resource and/or stored on the database. In this way, the revenue alignment component 226 may illustrate if an entity is revenue heavy (e.g., greater percentage of revenue generated than percentage of IP assets filed) or is more IP asset heavy (e.g., greater percentage of IP assets filed than percentage of revenue generated) for individual market areas and/or technology areas.

In some cases, the revenue alignment component 226 may also generate a metric illustrating a revenue alignment for multiple other entities. For example, the revenue alignment component 226 may determine a percentage of revenue generated in a market area and/or technology area of a total amount of revenue generated by a group of entities and may determine a percentage of IP assets directed to the one or more market areas and/or one or more technology areas from among a group of IP assets filed by the group of entities. In this way, the revenue alignment component 226 may illustrate a comparison of a revenue alignment metric associated with the entity to a revenue alignment metric associated with multiple other entities generating revenue and filing IP assets in an individual market area and/or technology area.

In some examples, the invalidity component 228 may make determinations and/or generate data to be displayed on the user interface. For example, a user may specify one or more target entities, one or more target publications, and/or one or more target products that the invalidity component 228 may utilize to generate a geographic distribution search. In some examples, the invalidity component 228 may be configured to identify one or more target entities utilizing data representing one or more target publications and/or one or more target products. The results of the invalidity search may include citation data associated with a group of IP assets and/or individual IP assets associated with an entity accessing the IP analysis platform. In some cases, the invalidity component 228 may generate an invalidity metric indicating a likelihood that an IP asset may be considered to be invalid if it were to be challenged in a court of law. In some cases, the invalidity component 228 may generate the invalidity metric based on a density of other IP assets cited during prosecution of the IP asset, a density of other IP assets in which the IP asset was cited during prosecution, and/or litigation data associated with the other IP assets (e.g., result of invalidity challenges of the other IP assets). In some cases, the invalidity metric may be utilized by other component and/or sub-components to impact other metrics, such as the comprehensive breadth score metric.

In some cases, the coverage component 212 may utilize (e.g., aggregate) any metric generated by the various sub-components to generate a coverage metric associated with a group of IP assets associated with an entity and/or other entities. In some cases, other determinations may affect the coverage metric, such as, legal status of an IP asset (e.g., ownership of the IP asset), how a breadth scope of claims change during prosecution of an IP asset, etc.

In some examples, the filing velocity component 230 may make determinations and/or generate data to be displayed on the user interface. For example, a user may specify one or more target entities, one or more target publications, and/or one or more target products that the filing velocity component 230 may utilize to generate a filing velocity search. In some examples, the filing velocity component 230 may be configured to identify one or more target entities utilizing data representing one or more target publications and/or one or more target products. The results of the filing velocity search may include a filing velocity metric indicating a percentile rank of an entity for filing of IP assets in a given market area and/or technology area. For example, the filing velocity component 230 may identify a total amount of IP assets filed that are directed towards or otherwise associated with a given market area and/or technology area for a period of time (e.g., a year, five years, ten years, etc.) The filing velocity component 230 may then identify a number of IP assets filed by individual entities, such as an entity accessing the IP analysis platform and associated entity competitors, during that time period directed towards or otherwise associated with the market area and/or the technology area. In some examples, the filing velocity component 230 may then generate a percentile ranking for each entity based at least in part on comparing the number of IP assets filed by the individual entities during the time period to the total number of IP assets filed during the time period. In some examples, the percentile ranking of each entity may be utilized as a metric for the opportunity component 214 to generate an opportunity metric. For example, a low percentile ranking (e.g., 10%, 20%, 30%) may indicate that an entity is underperforming with regard to a number of IP assets filed in a particular market area and/or technology area. Additionally, and/or alternatively, a high percentile ranking (e.g., 70%, 80%, 90%) may indicate that an entity is overperforming with regard to a number of IP assets filed in a particular market area and/or technology area. In some examples, the filing velocity component 230 may determine a threshold percentile (e.g., 50%) in which the filing velocity component 230 may compare the percentile ranking of the entity (e.g., based on the number of IP assets filed by the entity) to in order to determine how the percentile ranking may affect the opportunity metric. For example, a percentile ranking of the entity being below the threshold percentile may indicate that an entity is underperforming with regard to a number of IP assets filed in a particular market area and/or technology area. Additionally, and/or alternatively, a percentile ranking of the entity being above the threshold percentile may indicate that an entity is overperforming with regard to a number of IP assets filed in a particular market area and/or technology area.

In some examples, the filing velocity component 230 may identify a total amount of IP assets filed that are directed towards or otherwise associated with an IP art unit for a period of time (e.g., a year, five years, ten years, etc.) The filing velocity component 230 may then identify a number of IP assets filed by individual entities, such as an entity accessing the IP analysis platform and associated entity competitors, during that time period directed towards or otherwise associated with the IP art unit. In some examples, the filing velocity component 230 may then generate a percentile ranking for each entity based at least in part on comparing the number of IP assets filed by the individual entities during the time period to the total number of IP assets filed during the time period. In some examples, the percentile ranking of each entity may be utilized as a metric for the opportunity component 214 to generate an opportunity metric. For example, a low percentile ranking (e.g., 10%, 20%, 30%) may indicate that an entity is underperforming with regard to a number of IP assets filed in a particular IP art unit. Additionally, and/or alternatively, a high percentile ranking (e.g., 70%, 80%, 90%) may indicate that an entity is overperforming with regard to a number of IP assets filed in a particular IP art unit.

In some examples, the predictive analytics component 232 may make determinations and/or generate data to be displayed on the user interface. For example, a user may specify one or more target entities, one or more target publications, and/or one or more target products that the predictive analytics component 232 may utilize to generate a predictive analytics search. In some examples, the predictive analytics component 232 may be configured to identify one or more target entities utilizing data representing one or more target publications and/or one or more target products. The results of the predictive analytics search may include a predicted comprehensive breadth score for a pending IP asset associated with an entity. For example, the predictive analytics component 232 may determine an examiner and/or an art unit associated with at least one pending IP asset filed or otherwise associated with the entity. In some cases, the predictive analytics component 232 may determine a comprehensive breadth score, as discussed herein, for at least one originally filed claim of an IP asset (e.g., application) previously examined by the examiner and/or previously filed in the art unit. The predictive analytics component 232 may then determine a comprehensive breadth score for an issued version of the originally filed claim of the application and generate an examiner metric and/or an art unit metric based at least in part on a difference between the comprehensive breadth score of the originally filed claims and the comprehensive breadth score of the issued claims. In this way, the predictive analytics component 232 may determine an effect that a particular examiner and/or art unit may have on a comprehensive breadth score of a potentially allowable claim. For example, the predictive analytics component 232 may determine predicted breadth score for a pending IP asset based at least in part on the examiner metric and/or the art unit metric. In some cases, the predicted breadth score may be utilized by the opportunity component 214 to generate the opportunity metric.

In some cases, the predictive analytics component 232 may generate a predicted issue date for a pending IP asset associated with an entity based on an average length of prosecution associated with an examiner and/or an art unit. In some cases, the predicted issue date may be utilized by the opportunity component 214 to generate the opportunity metric.

In some examples, the precedence component 234 may make determinations and/or generate data to be displayed on the user interface. For example, a user may specify one or more target entities, one or more target publications, and/or one or more target products that the precedence component 234 may utilize to generate a precedence search. In some examples, the precedence component 234 may be configured to identify one or more target entities utilizing data representing one or more target publications and/or one or more target products. The results of the precedence search may include metric data indicating a historical precedence associated with an IP asset. For example, the precedence component 234 may identify a particular market area and/or technology area associated with an IP asset and determine a number of similar IP assets filed within the identified market area and/or technology area. In some examples, if the number of other IP assets is low, then the precedence metric associated with the IP asset may be high. Additionally, and/or alternatively, if the number of other IP assets is high, then the precedence metric associated with the IP asset may be low. Once the precedence component 234 determines a precedence metric, the precedence metric may be provided to the opportunity component 214 and utilized to generate the opportunity metric.

In some examples, the innovation metric component 246 may make determinations and/or generate data to be displayed on the user interface. For example, a user may specify one or more target entities, one or more target publications, one or more target markets, one or more target technology areas, and/or one or more target products that the innovation metric component 246 may utilize to generate an innovation metric. In some cases, the innovation metric may provide an indication that an entity, a technology area, and/or a market is associated with architectural innovation, incremental innovation, radical innovation, and/or disruptive innovation. In some case, the innovation metric may be obtained by calculating (e.g., by the IP analysis platform) an amount of time since an average filing date of IP assets in a grouping over a fixed time period. In some cases, a more recent average filing date may be a proxy for a better innovation metric. By way of example, the innovation metric component 246 may identify an entity, a technology space, and/or a market associated with IP assets and determine a respective filing date associated with each IP asset of the IP assets between a first date and a second date. For example, the innovation metric component 246 may access the data store 124 containing an IP asset library 210 to obtain information associated with each of the IP assets. In some case, the innovation metric component 246 may determine an average filing date associated with the IP assets filed between the first date and the second date and determine an amount of time between the average filing date and the second date. For example, the IP assets associated with the entity, the technology space, and/or the market may have an average filing date between a 10-year period (e.g., between the year 2000 and the year 2010) of Dec. 31, 2007. In this example, the first date being Jan. 1, 2000, and the second date being Dec. 31, 2010, the amount of time between the average filing date and the second date would be 3-years. In some cases, the innovation metric component 246 may generate a score associated with the entity, the technology space, and/or the market based on the amount of time. For example, a more recent average filing date would equate to a shorter period of time between the average filing date and the second date and thus, be a proxy for a better innovation metric.

In some cases, the innovation metric component 246 may be configured to determine additional metrics associated with the innovation metric. For example, the innovation metric component 246 may determine a normalized innovation metric and/or a percentile innovation metric. For example, regarding the normalized innovation metric, across a given group of IP assets, the innovation metric may be normally distributed. The innovation metric component 246 may configure the innovation metric to reflect a position of a particular innovation metric by its distance from a mean in standard deviation units. Thus, if an entities, technology spaces, and/or markets innovation metric is equal to a mean innovation metric from a group of innovation metrics of similar entities, technology spaces, and/or markets, then that normalized innovation metric is zero. If an entities, technology spaces, and/or markets innovation metric is one standard deviation from the mean, then its normalized innovation metric will be 1 or −1 depending on if it is greater or less than the mean innovation metric. In some cases, regarding the percentile innovation metric, the innovation metric component 246 may set a lowest innovation metric from a group of innovation metrics to zero and the highest innovation metric to 100 and order all the innovation metrics in between according to the percentile that they fall into. In this case, each innovation metric may be associated with a particular entity, technology space, and/or market deemed to be similar by the IP analysis system. The percentile framework provides a way to directly compare entities, technology spaces, and/or markets with each other by comparing the magnitude of their percentile score (e.g., 100 being the highest percentile innovation metric and 0 being the lowest percentile innovation metric).

In some cases, the opportunity component 214 may utilize (e.g., aggregate) any metric generated by the various sub-components to generate an opportunity metric associated with a group of IP assets associated with an entity and/or other entities.

In some examples, the litigation campaign component 236 may make determinations and/or generate data to be displayed on the user interface. For example, a user may specify one or more target entities, one or more target publications, and/or one or more target products that the litigation campaign component 236 may utilize to generate a litigation campaign search. In some examples, the litigation campaign component 236 may be configured to identify one or more target entities utilizing data representing one or more target publications and/or one or more target products. The results of the litigation campaign search may include data indicating a potential likelihood of litigation associated with a particular market area and/or technology area. For example, the litigation campaign component 236 may identify a litigation campaign associated with a market area and/or technology area by determining that an entity has filed at least two cases associated with the market area and/or technology area within the same calendar year. Once the litigation campaign component 236 determines that the at least two cases are part of a litigation campaign directed towards a particular market area and/or technology area, the litigation campaign component 236 may determine a period of time since the most recent filing of a case included in the litigation campaign, a number of defendants associated with the litigation campaign, and/or a non-practicing entity (NPE) status of the litigation campaign (e.g., whether the entity associated with the litigation campaign is an NPE or a practicing entity). In some examples, the litigation campaign component 236 may obtain litigation data (e.g., defendant information, plaintiff information, case filing information, etc.) from a third-party resource and may store the data in the database. In some cases, the data generated by the litigation campaign component 236 may be provided to the exposure component 216 and utilized to generate an exposure metric.

In some examples, the alignment to exposure component 238 may make determinations and/or generate data to be displayed on the user interface. For example, a user may specify one or more target entities, one or more target publications, and/or one or more target products that the alignment to exposure component 238 may utilize to generate an alignment to exposure search. In some examples, the alignment to exposure component 238 may be configured to identify one or more target entities utilizing data representing one or more target publications and/or one or more target products. The results of the alignment to exposure search may include metric data indicating a potential exposure metric associate with a group of IP assets associated with an entity with regard to potential litigation. For example, the alignment to exposure component 238 may determine a market area and/or technology area associated with a group of IP assets filed and/or otherwise associated with an entity, such as an entity utilizing the IP analysis platform. The alignment to exposure component 238 may then identifying a litigation history (e.g., past litigation and current litigation) associated with the technology area and/or market area. In some cases, if there is a large amount of litigation associated with the market area and/or technology area, the alignment to exposure component 238 may determine that the group of IP assets are at a greater risk of litigation. Additionally, and/or alternatively, if there is a small amount of litigation associated with the market area and/or technology area, the alignment to exposure component 238 may determine that the group of IP assets are at a lesser risk of litigation. In some cases, the data generated by the alignment to exposure component 238 may be provided to the exposure component 238 and utilized to generate an exposure metric.

In some examples, the scoring component 122 may utilize data received from and/or metrics generated by the coverage component 212, the opportunity component 214, the exposure component 216, and the respective metrics associated with each component to generate an overall score for a group of IP assets associated with an entity. The overall score may indicate i) an overall coverage and/or identify gaps in coverage: ii) a potential market opportunity; and/or iii) a potential exposure associated with the IP assets. included in the targeted technical fields, subject matters, and/or competitor entities portfolios.

In some examples, the scoring component 122 may be configured to receive data representing a seeded search query and may perform a search operation in a number of ways and provide data and/or metrics to the various other components and sub-components discussed herein. A seeded search query may include one or more instances of target data. In some examples, the seeded search query may indicate an identification of one or more target entities. Additionally, or alternatively, the seeded search query may indicate an identification of one or more target publications, such as, for example, an IP asset. Additionally, or alternatively, the seeded search query may indicate an identification of one or more target products and/or services. In some examples, the IP analysis platform may be configured to receive additional data associated with the seeded search query. For example, the scoring component 122 may be configured to receive additional data via one or more actionable elements included on a graphical user interface (GUI) presented on a computing device and accessible to a user account. Additionally, or alternatively, the scoring component 122 may be configured to utilize the data representing a seeded search query to make various identifications and determinations associated with IP assets and/or entities, among other things.

The user interface generation component 240 may be configured to generate user interface element(s), window(s), page(s), and/or view(s) described below with respect to FIGS. 3-5 using data received from other components utilized by the IP analysis platform. In some examples, the user interface generation component 240 may be communicatively coupled to the other components stored thereon the computer-readable media 120. In some examples, the user interface generation component 240 may generate user interfaces configured to present information associated with user account(s) 202 data, analysis report(s) 204 data, and/or saved results 242. Additionally, or alternatively, the user interface generation component 240 may generate user interfaces including confidential information and may be configured to be accessible by only users with predetermined qualifications. For example, the user interface generation component 240 may cause only a portion of information to be displayed based on the type of account that is accessing the platform. For example, when a user accesses the system, the user interface generation component 240 may determine that the account type of the account that the user has utilized to access the system may be one of, for example, an internal user and/or an external user, and may only include a portion of the information to be displayed that is associated with that account type. In some examples, the user interface generation component 240 may generate notifications to send to the user accounts.

As mentioned with respect to FIG. 1, the probability component may be configured to train one or more ML models, based on various data in the data store 124, to generate an IPO probability indicator representing a probability that a given candidate private company will have an IPO event within a threshold period of time (e.g., within the next 1-N years, with N being any integer greater than 1). The probability component may include one or more components, such as, for example, one or more ML model(s) and/or a training component. Additionally, or alternatively, the probability component may be configured to perform the operations described below with respect to the one or more components.

A machine learning (ML) component 248 may be configured to train one or more ML model(s) using machine-learning mechanisms. For example, a machine-learning mechanism can analyze historical data 208, market data 244, and/or any other type of data stored or otherwise accessible by the data store 124, associated with one or more entities, technology spaces, and/or markets, configured as training data to train a data model that creates an output, which can be a recommendation, a score, a respective probability, a threshold probability, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in the data store(s) 124 associated with remote computing resources 104 for use at a time after the data models have been trained (e.g., at runtime). Additionally, or alternatively, in at least one example, the machine-learning mechanisms may include an extreme gradient boosting (XGBoost) ML algorithm, a multi-layered perception ML algorithm, a random forest ML algorithm, and/or the like. In some examples, an innovation metric may be generated using at least one ML model trained by the machine learning component 248 based on company data 202 associated with historical data 208, market data 244, and/or any other type of data stored or otherwise accessible by the data store 124, associated with one or more entities, technology spaces, and/or markets, configured as training data.

Once the ML model(s) are trained by the machine learning component 248, the ML model(s) may output an innovation metric for a given entity, technology space, and/or market. In some examples, the innovation metric may be a percentage ranging from 0% to 100%, such as with the percentile innovation metric discussed herein. Additionally and/or alternatively, the innovation metric output by the ML model(s) may include a normalized innovation metric, as discussed herein, indicating an integer value difference from a mean innovation metric from a group of innovation metrics of similar entities, technology spaces, and/or markets.

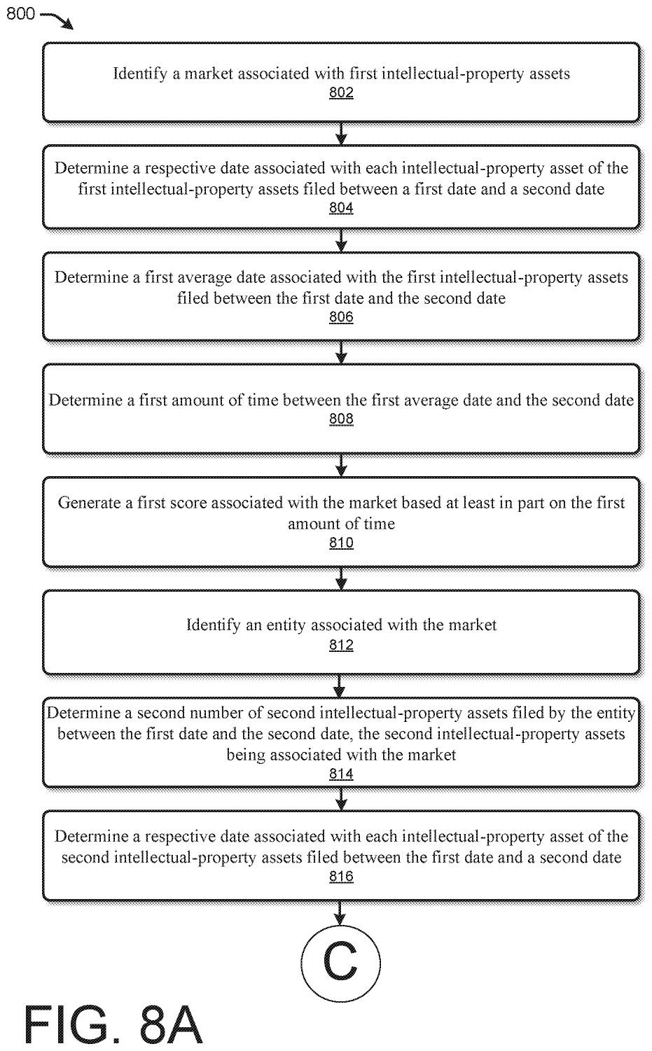

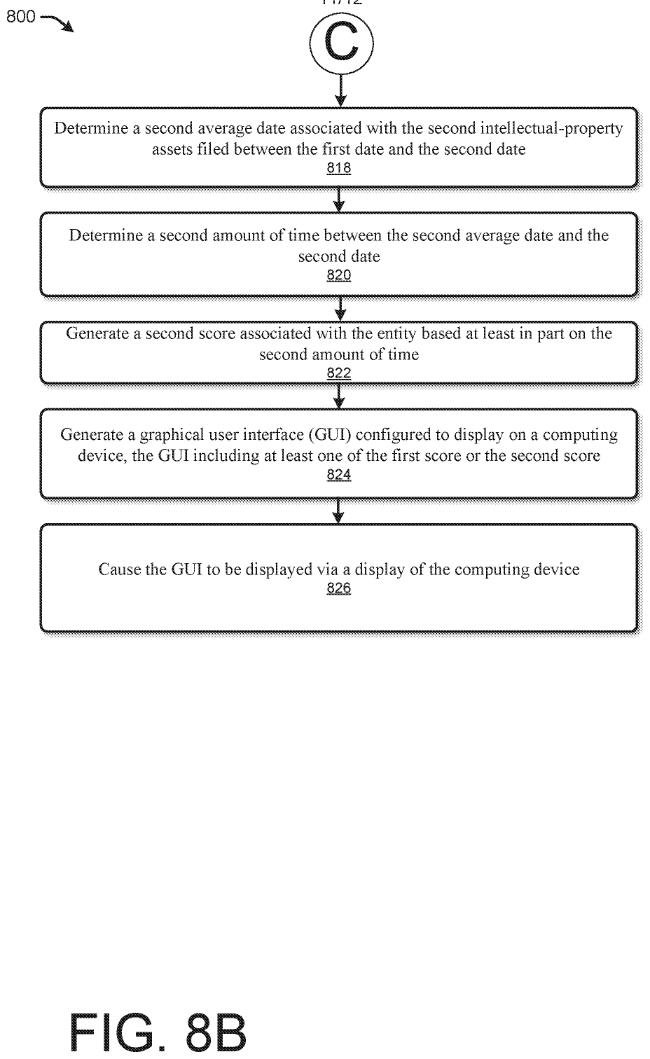

FIGS. 3-6 illustrate conceptual diagrams of example user interface(s) 300-600 that may receive user input and utilize the IP analysis platform to perform the various operations described above with respect to FIGS. 1 and 2 and/or the various operations described below with respect to FIGS. 8-10. The user interface(s) 300-600 may be generated by the user interface generation component 240 described with respect to FIG. 2 above. The user interface(s) 300-600 may be displayed on a display of an electronic device associated with a user account, such as the electronic device 102 as described with respect to FIG. 1 above. While example user interface(s) 300-600 are shown in FIGS. 3-6, the user interface(s) 300-600 are not intended to be construed as a limitation, and the user interface(s) 300-600 may be configured to present any of the data described herein.

FIG. 3 illustrates an example user interface 300 for displaying a market analysis page 302 and may be displayed on a display of an electronic device associated with a user account, such as, for example, the electronic device 102 as described with respect to FIG. 1 above.

In some examples, the market analysis page 302 may include a number of views that may be presented in response to selection of a corresponding view selection element and/or in response to a search query receive by a user. For example, the market analysis page 302 may display one or more markets 304 associated with an entity and/or identified by a user as well as one or more metrics generated by the sub-components of the IP analysis platform. For example, the market analysis page 302 may display a comprehensive breadth score metric 306 associated with IP assets directed towards each market and/or technology area, a research and development value 308 spent by entities that were directed towards each market and/or technology area, a revenue value 310 generated by entities from each market and/or technology area, and/or a an innovation metric 312 associated with IP assets that are identified as being associate with each market and/or technology area of each market. In some cases, the data used to generate the market analysis page 302 may be obtained by any one of the components discussed herein, from a third-party source (e.g., publicly available data source) and/or the historical data 208 and/or the market data 244.

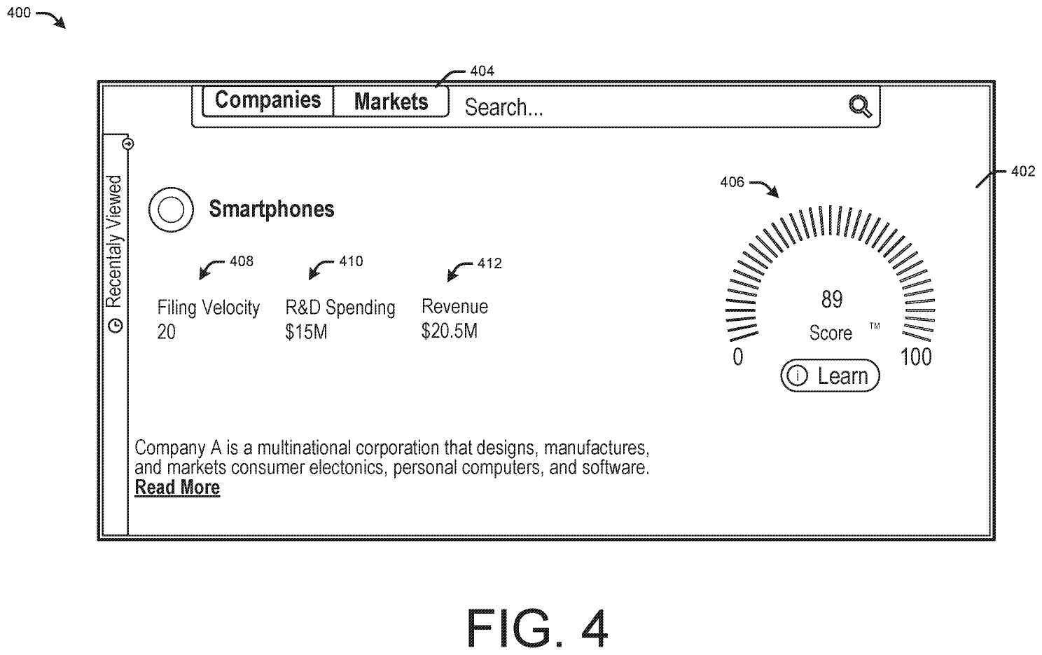

FIG. 4 illustrates an example user interface 400 configured to present data associated with a user account representing a user created IP analysis reports(s) associated with a user account. The user interface 400 may include a market score page 402 and be displayed on a display of an electronic device associated with a user account, such as, for example, the electronic device 102 as described with respect to FIG. 1 above.

In some examples, the market score page 402 may include a number of views that may be presented in response to selection of a corresponding view selection element 404 (e.g., for switching to the company analysis page discussed below). For example, the market score page 402 may display the innovation metric 406 indicating an innovation metric (sometimes referred to as an innovation score) associated with the IP asset portfolio and/or a subset of the IP asset portfolio associated with the selected market (e.g., smartphones). The market score page 402 may also display other metrics associated with the market, such as a filing velocity score 408, R&D spending data 410, and/or revenue data 412 that are determined and/or otherwise generated by the IP analysis platform. The market score page 402 may also include other information (e.g., company name, location, website, revenue data, employee data, and/or summary data) associated with the market, a technology space, and/or an entity in which the analysis report is based on.

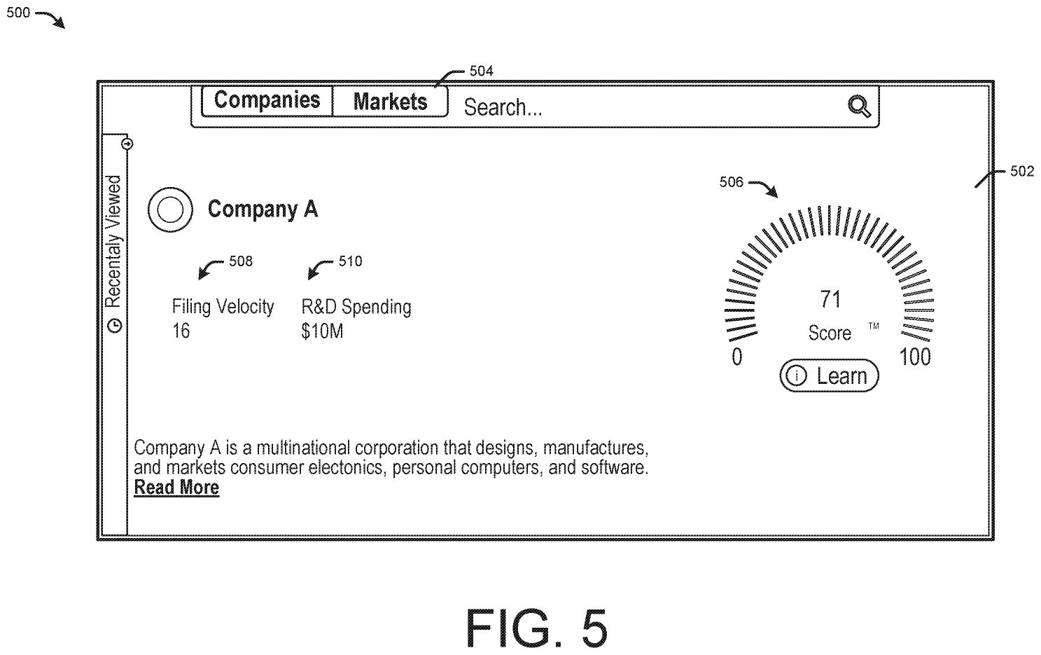

FIG. 5 illustrates an example user interface 500 configured to present data associated with a user account representing a user created IP analysis reports(s) associated with a user account. The user interface 500 may include an entity score page 502 and be displayed on a display of an electronic device associated with a user account, such as, for example, the electronic device 102 as described with respect to FIG. 1 above.

In some examples, the entity score page 502 may include a number of views that may be presented in response to selection of a corresponding view selection element 504 (e.g., for switching to the company analysis page). For example, the entity score page 502 may display the innovation metric 506 indicating an innovation metric (sometimes referred to as an innovation score) associated with the IP asset portfolio and/or a subset of the IP asset portfolio associated with the selected entity. The entity score page 502 may also display other metrics associated with the entity, such as a filing velocity score 508, and/or R&D spending data 510 that are determined and/or otherwise generated by the IP analysis platform. The entity score page 502 may also include other information (e.g., company name, location, website, revenue data, employee data, and/or summary data) associated with a market, a technology space, and/or the entity in which the analysis report is based on.

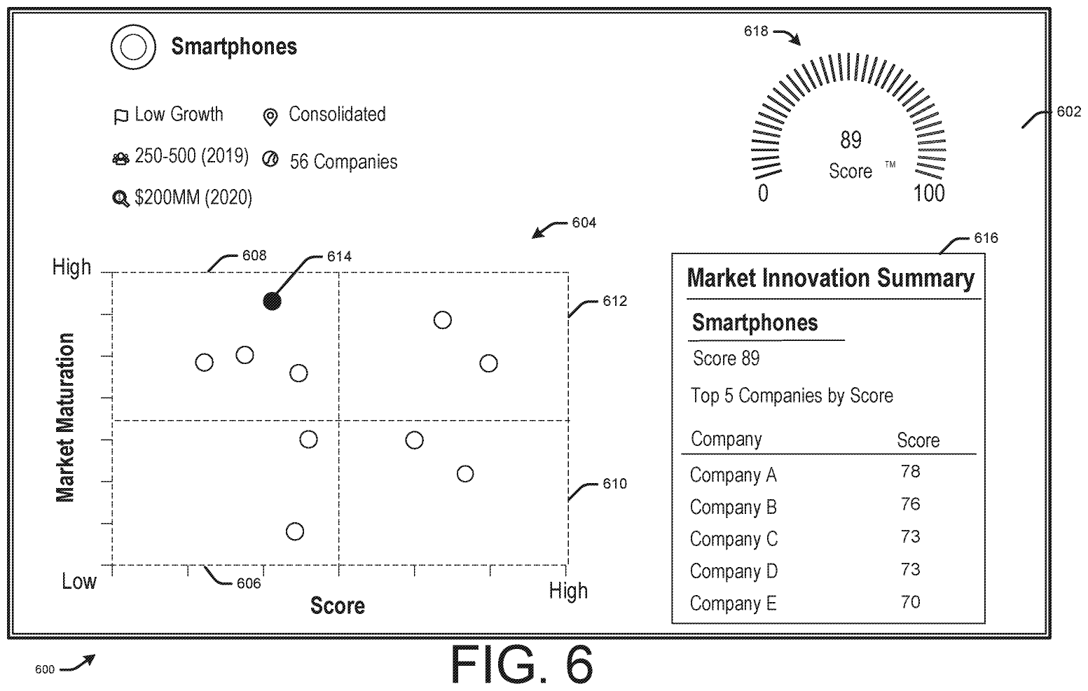

FIG. 6 illustrates an example user interface 600 configured to present data associated with a user account representing a user created IP analysis reports(s) associated with a user account. The user interface 600 may include an innovation metric page 602 and be displayed on a display of an electronic device associated with a user account, such as, for example, the electronic device 102 as described with respect to FIG. 1 above.

In some examples, the innovation metric page 602 may include a number of views that may be presented in response to selection of a corresponding view selection element. For example, the IP analysis platform may determine an innovation metric associated with an entity, a technology area, and/or a market. The innovation metric may indicate different types of innovation associated with the entity, the technology area, and/or the market. For example, an innovation metric may be associated with different types of innovation, such as, but not limited to, radical innovation, disruptive innovation, architectural innovation, and/or incremental innovation. A radical innovation metric may indicate that the entity, the technology area, and/or the market is associated with a new product or service being developed using a new technology that opens up to new markets. For example, pharmaceutical researchers often produce a new product that is radical innovation such as a new combination of chemicals to treat a medical condition that attracts new buyers. A disruptive innovation metric may indicate and/or otherwise be associated with innovation that conflicts with, and threatens to replace, traditional approaches to competing within an industry. Disruptive innovation occurs when a new product or service engages the existing market with a new technology. For example, digital cameras disrupted the photography industry by offering instant gratification and eliminating the cost of getting film developed. An architectural innovation metric may indicate and/or otherwise be associated with new products or services that use existing technology to create new markets and/or new consumers that did not purchase that item before. For example, smart watch used existing cell phone technology and was repackaged into a watch. An incremental innovation metric may indicate and/or otherwise be associate with improvements on an existing product or service. The improvements may be based on using existing technology and are directed at the existing market. For example, residential washers and dryers have been transitioning from top-loading to side-loading, and can handle larger loads. This incremental innovation used existing technology and created no new markets, but stimulated demand for more purchasers at higher prices. In some cases, the innovation metric page may display an innovation metric associated with an entity, a technology area, and/or a market such that a user, such as a potential investor, may understand which markets are most innovative (e.g., markets that fall into a radical innovation category or a disruptive innovation category), which companies are efficiently innovating (e.g., companies that are producing intellectual-property that is contributing to revenue grown while efficiently using research and development spending), among other types of information.

The innovation metric page 602 may include a quadrant graph 604 illustrating innovation metrics (e.g., along the X-axis) with respect to a market's maturation value (e.g., along the Y-axis.). Each dot on the quadrant graph may represent a different market located in either an incremental quadrant 606 associated with incremental innovation, architectural innovation quadrant 608 associated with architectural innovation, disruptive innovation quadrant 610 associated with disruptive innovation, and/or radical innovation quadrant 612 associated with radical innovation. In some cases, selecting one of the dots on the quadrant graph 604 may cause additional information to be presented on the innovation metric page 602. For example, the dot 614 may represent the smartphone market and selection of dot 614 may cause details associated with the smartphone market to be presented. For instance, a market innovation summary window 616 may present additional data, such as the innovation score associate with the smartphone market and the top scoring (e.g., top 5, top 10, etc.) companies within the smartphone market having the highest innovation metric. The innovation metric page 602 may be configured to present different information in the market summary window 616 depending on which dot is selected via the quadrant graph 604 (e.g., selecting a different dot representing a different market will display the top innovation metric scoring companies associated with that selected market).

In some cases, a market maturation value (e.g., a value attributed to the Y-axis of the quadrant graph 604) may be determined for each market represented on the quadrant graph 604. In some cases, the market maturation value may indicate a length of time in which a particular market has been in existence. For example, the market maturation value may be determined based on when a product and/or products associated with a particular market were made available for purchase (e.g., made publicly available) and/or were otherwise introduced to the public (e.g., via a public disclosure). In some examples, the dates used to determine the market maturation values may be based on the same and/or similar dates used to determine the innovation metrics. For example, if an innovation metric was being determined for a particular market between the years of 1981 and 2001, then the market maturation value may be determined by calculating the length of time since a product and/or products associated with the particular market were publicly disclosed within that time period up to 2001. In some cases, the market maturation values may be determined based on other information, such as dates associated with first public disclosures and/or market introduction of discrete non-IP entities and/or items associated with a market (e.g., products, services, and/or their associated brands and/or trademarks). In some cases, this information may be obtained from one or more third-party data sources.

In some cases, the Y-axis values used to generate the quadrant graph 604 may include other information associate with a market. For example the Y-axis values used to generate the quadrant graph 604 may be based on dates associated with multiple items (e.g., products, services, trademarks, etc.) within a market. In some cases, the information may include an average, a mean, and/or median item start (e.g., birth) and end (e.g., death) dates (or a ratio of the two) for the associated items.

In some examples, the innovation metric page 602 may display the innovation metric 618 indicating an innovation metric (sometimes referred to as an innovation score) associated with the IP asset portfolio and/or a subset of the IP asset portfolio associated with the selected market (e.g., smartphones). The innovation metric page 602 may also display other metrics associated with the market, such as a filing velocity score, R&D spending data, revenue data, number of employees, number of companies, and/or a type of consolidation, that are determined and/or otherwise generated by the IP analysis platform. The innovation metric page 602 may also include other information (e.g., company name, location, website, revenue data, employee data, and/or summary data) associated with the market, a technology space, and/or an entity in which the analysis report is based on.

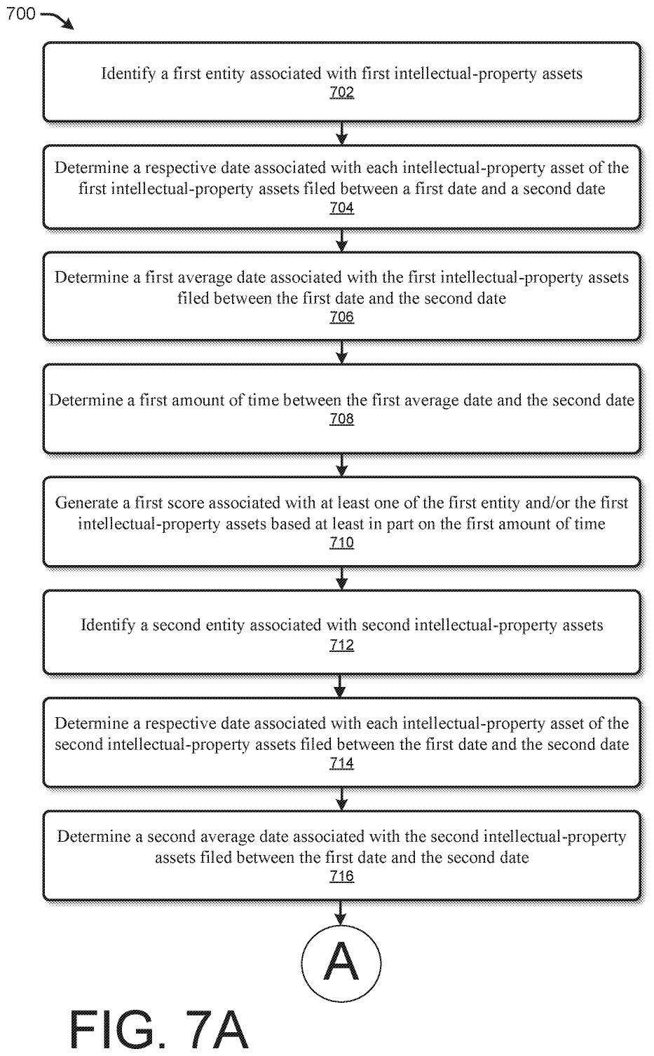

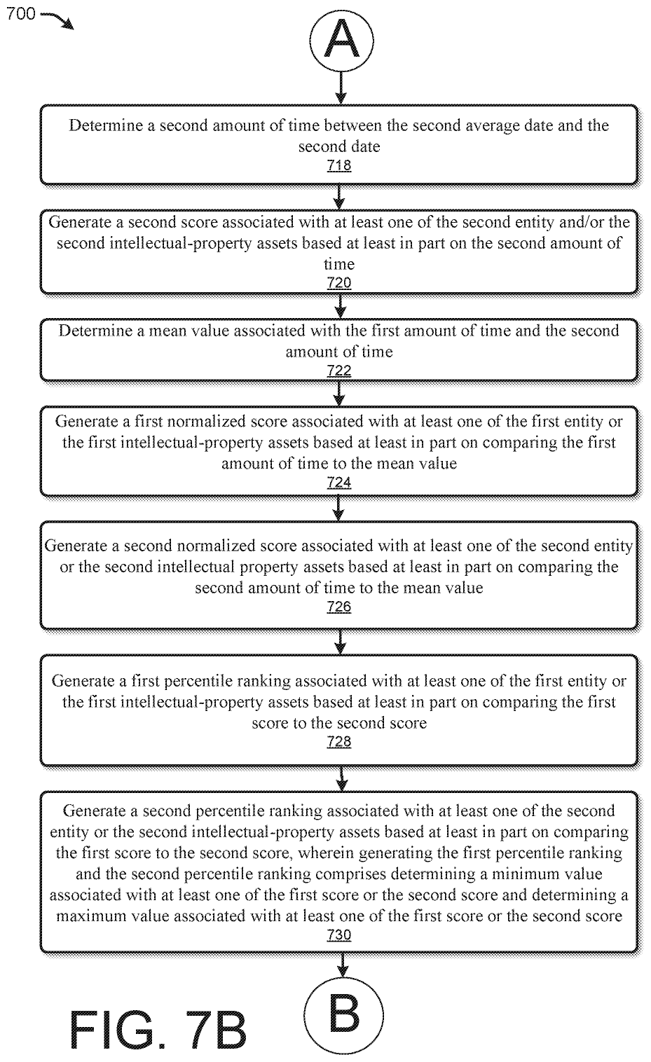

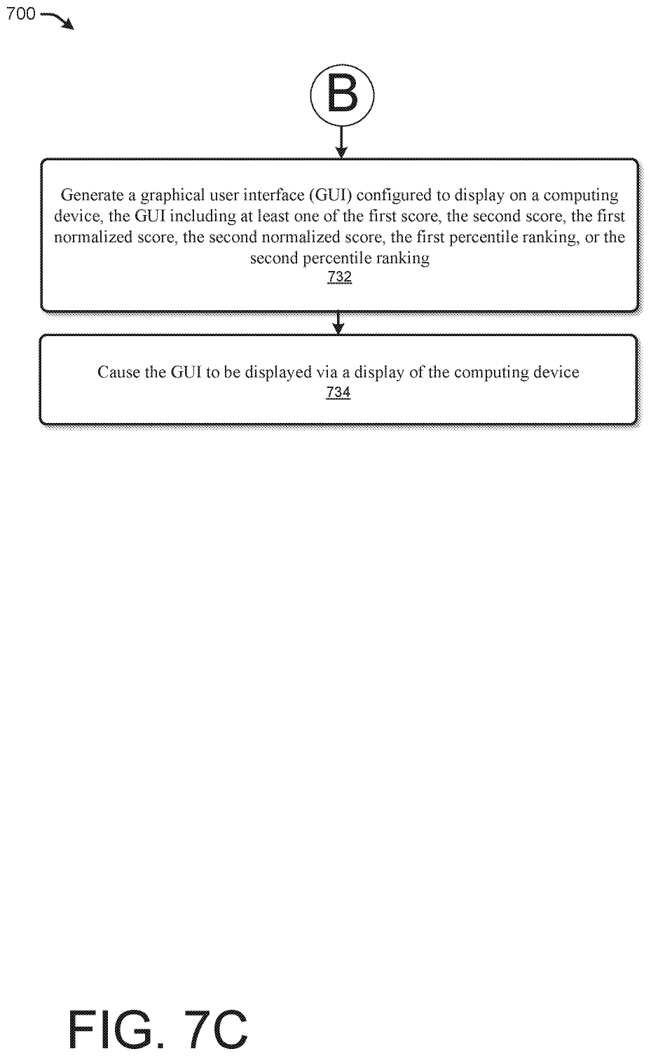

FIGS. 7-9 illustrate example processes associated with the IP analysis platform. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-6, although the processes may be implemented in a wide variety of other environments, architectures and systems.

FIG. 7 illustrates an example flow diagram of an example process 700 for utilizing a target entity having IP assets generate a user interface configured to present an analysis of the IP assets. The order in which the operations or steps are described is not intended to be construed as a limitation, and any number of the described operations may be combined in any order and/or in parallel to implement process 700. The operations described with respect to the process 700 are described as being performed by an electronic device and/or a remote computing resource associated with the IP analysis platform. However, it should be understood that some or all of these operations may be performed by some or all of components, devices, and/or systems described herein.

At block 702, the process 700 may include identifying a first entity associated with first intellectual-property assets.

At block 704, the process 700 may include determining a respective date associated with each intellectual-property asset of the first intellectual-property assets filed between a first date and a second date.

At block 706, the process 700 may include determining a first average date associated with the first intellectual-property assets filed between the first date and the second date.

At block 708, the process 700 may include determining a first amount of time between the first average date and the second date.

At block 710, the process 700 may include generating a first score associated with at least one of the first entity and/or the first intellectual-property assets based at least in part on the first amount of time.

At block 712, the process 700 may include identifying a second entity associated with second intellectual-property assets.

At block 714, the process 700 may include determining a respective date associated with each intellectual-property asset of the second intellectual-property assets filed between the first date and the second date.

At block 716, the process 700 may include determining a second average date associated with the second intellectual-property assets filed between the first date and the second date.

At block 718, the process 700 may include determining a second amount of time between the second average date and the second date.

At block 720, the process 700 may include generating a second score associated with at least one of the second entity and/or the second intellectual-property assets based at least in part on the second amount of time.

At block 722, the process 700 may include determining a mean value associated with the first amount of time and the second amount of time.

At block 724, the process 700 may include generating a first normalized score associated with at least one of the first entity or the first intellectual-property assets based at least in part on comparing the first amount of time to the mean value.

At block 726, the process 700 may include generating a second normalized score associated with at least one of the second entity or the second intellectual property assets based at least in part on comparing the second amount of time to the mean value.

At block 728, the process 700 may include generating a first percentile ranking associated with at least one of the first entity or the first intellectual-property assets based at least in part on comparing the first score to the second score.

At block 730, the process 700 may include generating a second percentile ranking associated with at least one of the second entity or the second intellectual-property assets based at least in part on comparing the first score to the second score, wherein generating the first percentile ranking and the second percentile ranking comprises determining a minimum value associated with at least one of the first score or the second score and determining a maximum value associated with at least one of the first score or the second score.

At block 732, the process 700 may include generating a graphical user interface (GUI) configured to display on a computing device, the GUI including at least one of the first score, the second score, the first normalized score, the second normalized score, the first percentile ranking, or the second percentile ranking. and

At block 734, the process 700 may include causing the GUI to be displayed via a display of the computing device.

Additionally and/or alternatively, the process 700 may include identifying at least one of a first market or a first technology associated with third intellectual-property assets, determining a respective date associated with each intellectual-property asset of the third intellectual-property assets filed between the first date and the second date, determining a third average date associated with the third intellectual-property assets filed between the first date and the second date, determining a third amount of time between the third average date and the second date, generating a third score associated with at least one of the first market, the first technology, and/or the third intellectual-property assets based at least in part on the third amount of time.

Additionally and/or alternatively, the process 700 may include associating at least one of the first score, the second score, the first normalized score, the second normalized score, the first percentile ranking, or the second percentile ranking with an innovation score, wherein the innovation score is associated with at least one of architectural innovation, incremental innovation, radical innovation, or disruptive innovation.

Additionally and/or alternatively, the process 700 may include determining at least one of a portfolio quality score associated with at least one of the first entity or the second entity, a filing velocity score associated with at least one of the first entity or the second entity, a revenue associated with at least one of the first entity or the second entity, a research and development score associated with at least one of the first entity or the second entity, or a prosecution cost score associated with at least one of the first entity or the second entity, wherein the innovation score is based at least in part on the portfolio quality score, the filing velocity score, the research and development score, the revenue, the prosecution cost score, the first score, the second score, the first normalized score, the second normalized score, the first percentile ranking, or the second percentile ranking.

Additionally and/or alternatively, the process 700 may include the GUI comprising a quadrant graph comprising: a first section associated with architectural innovation: a second section associated with incremental innovation: a third section associated with radical innovation; and a fourth section associated with disruptive innovation.

Additionally and/or alternatively, the process 700 may include determining a number of intellectual-property assets associated with the first-entity that have been published between the first date and the second date, wherein at least one of the first score, the first percentile ranking, or the first normalized score is based at least in part on the number of intellectual-property assets associated with the first-entity that have been published between the first date and the second date.

Additionally and/or alternatively, the process 700 may include at least one of the first score, the second score, the first normalized score, the second normalized score, the first percentile ranking, or the second percentile ranking being determined using machine learning.

Additionally and/or alternatively, the process 700 may include at least one of the first score, the second score, the first normalized score, the second normalized score, the first percentile ranking, or the second percentile ranking being determined using a quadratic regression.

FIG. 8 illustrates an example flow diagram of an example process 800 for utilizing a target market having IP assets generate a user interface configured to present an analysis of the IP assets. The order in which the operations or steps are described is not intended to be construed as a limitation, and any number of the described operations may be combined in any order and/or in parallel to implement process 800. The operations described with respect to the process 800 are described as being performed by an electronic device and/or a remote computing resource associated with the IP analysis platform. However, it should be understood that some or all of these operations may be performed by some or all of components, devices, and/or systems described herein.

At block 802, the process 800 may include identifying a market associated with first intellectual-property assets.

At block 804, the process 800 may include determining a respective date associated with each intellectual-property asset of the first intellectual-property assets filed between a first date and a second date.

At block 806, the process 800 may include determining a first average date associated with the first intellectual-property assets filed between the first date and the second date.

At block 808, the process 800 may include determining a first amount of time between the first average date and the second date.

At block 810, the process 800 may include generating a first score associated with the market based at least in part on the first amount of time.

At block 812, the process 800 may include identifying an entity associated with the market.

At block 814, the process 800 may include determining a second number of second intellectual-property assets filed by the entity between the first date and the second date, the second intellectual-property assets being associated with the market.

At block 816, the process 800 may include determining a respective date associated with each intellectual-property asset of the second intellectual-property assets filed between the first date and a second date.

At block 818, the process 800 may include determining a second average date associated with the second intellectual-property assets filed between the first date and the second date.

At block 820, the process 800 may include determining a second amount of time between the second average date and the second date,

At block 822, the process 800 may include generating a second score associated with the entity based at least in part on the second amount of time.

At block 824, the process 800 may include generating a graphical user interface (GUI) configured to display on a computing device, the GUI including at least one of the first score or the second score.

At block 826, the process 800 may include causing the GUI to be displayed via a display of the computing device.

Additionally and/or alternatively, the process 800 may include at least one of the first score or the second score being associated with at least one of architectural innovation, incremental innovation, radical innovation, or disruptive innovation.

Additionally and/or alternatively, the process 800 may include determining a maturity score associating with the market, wherein the at least one of the first score or the second score is based at least in part on the maturity score.

Additionally and/or alternatively, the process 800 may include the GUI comprising a quadrant comprising: a first section associated with architectural innovation, a second section associated with incremental innovation, a third section associated with radical innovation, and a fourth section associated with disruptive innovation.

Additionally and/or alternatively, the process 800 may include at least one of the first score or the second score being based at least in part on a number of intellectual-property assets associated with the market that have been published between the first date and the second date.

Additionally and/or alternatively, the process 800 may include the at least one of the first score or the second score is determined using machine learning.

Additionally and/or alternatively, the process 800 may include The method of claim 1, wherein the at least one of the first score or the second score being determined using a quadratic regression.

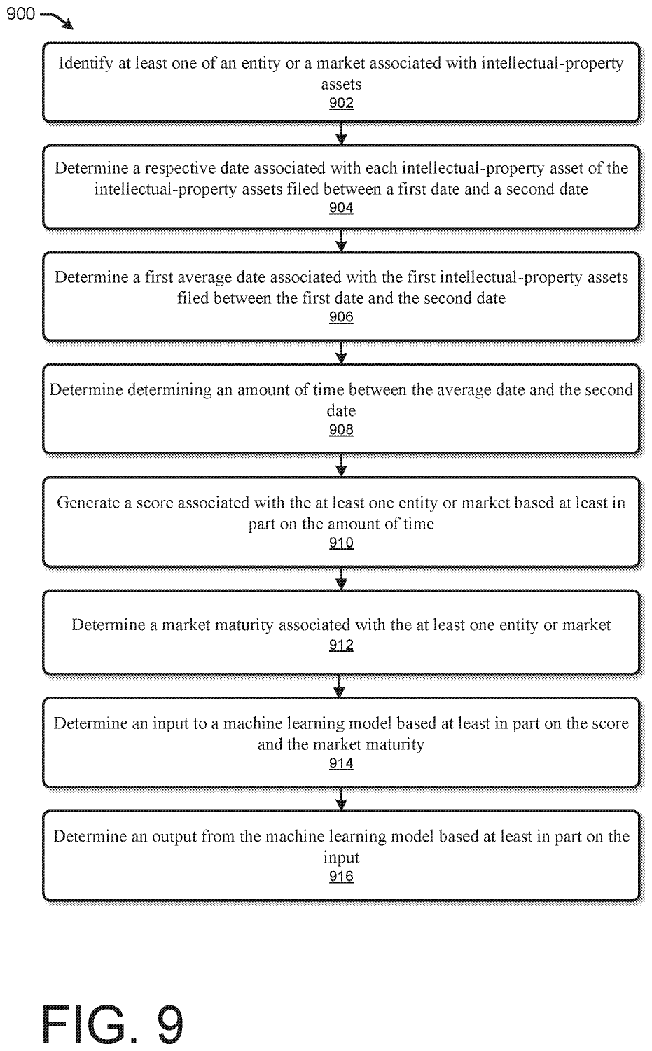

FIG. 9 illustrates an example flow diagram of an example process 900 for utilizing a target market and/or entity having IP assets generate a user interface configured to present an analysis of the IP assets. The order in which the operations or steps are described is not intended to be construed as a limitation, and any number of the described operations may be combined in any order and/or in parallel to implement process 900. The operations described with respect to the process 900 are described as being performed by an electronic device and/or a remote computing resource associated with the IP analysis platform. However, it should be understood that some or all of these operations may be performed by some or all of components, devices, and/or systems described herein.

At block 902, the process 900 may include identifying at least one of an entity or a market associated with intellectual-property assets.

At block 904, the process 900 may include determining a respective date associated with each intellectual-property asset of the intellectual-property assets filed between a first date and a second date.

At block 906, the process 900 may include determining an average date associated with the intellectual-property assets filed between the first date and the second date,

At block 908, the process 900 may include determining an amount of time between the average date and the second date.

At block 910, the process 900 may include generating a score associated with the at least one entity or market based at least in part on the amount of time,

At block 912, the process 900 may include determining a market maturity associated with the at least one entity or market.

At block 914, the process 900 may include determining an input to a machine learning model based at least in part on the score and the market maturity.

At block 916, the process 900 may include determining an output from the machine learning model based at least in part on the input.

Additionally and/or alternatively, the process 900 may include associating the score with an innovation score, wherein the innovation score is associated with at least one of architectural innovation, incremental innovation, radical innovation, or disruptive innovation.

The system of claim 17, further comprising determining at least one of a portfolio quality score associated with the at least one entity or market, a filing velocity score associated with the at least one entity or market, a revenue associated with the at least one entity or market, a research and development score associated with the at least one entity or market, or a prosecution cost score associated with the at least one entity or market, wherein the innovation score is based at least in part on the portfolio quality score, the filing velocity score, the research and development score, the revenue, the prosecution cost score, the score, or the market maturity.

Additionally and/or alternatively, the process 900 may include the GUI comprising a quadrant comprising: a first section associated with architectural innovation, a second section associated with incremental innovation, a third section associated with radical innovation, and a fourth section associated with disruptive innovation.

Additionally and/or alternatively, the process 900 may include determining a number of intellectual-property assets associated with the at least one entity or market that have been published between the first date and the second date, wherein the score is based at least in part on the number of intellectual-property assets associated with the at least one entity or market that have been published between the first date and the second date.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A method comprising:
identifying a first entity associated with first intellectual-property (IP) assets:
determining a respective date associated with individual ones of the first IP assets filed between a first date and a second date, the respective date comprising at least one of a filing date, a publication date, or a priority date:
determining a first average date associated with the first IP assets filed between the first date and the second date:
determining a first amount of time between the first average date and the second date;
generating a first score associated with at least one of the first entity or the first IP assets based at least in part on the first amount of time:
identifying a second entity associated with second IP assets:
determining a respective date associated with individual ones of the second IP assets filed between the first date and the second date:
determining a second average date associated with the second IP assets filed between the first date and the second date:
determining a second amount of time between the second average date and the second date:
generating a second score associated with at least one of the second entity and/or the second IP assets based at least in part on the second amount of time:
determining a mean value associated with the first amount of time and the second amount of time:
generating a first normalized score associated with at least one of the first entity or the first IP assets based at least in part on comparing the first amount of time to the mean value:
generating a second normalized score associated with at least one of the second entity or the second IP assets based at least in part on comparing the second amount of time to the mean value:
generating a first percentile ranking associated with at least one of the first entity or the first IP assets based at least in part on comparing the first score to the second score:
generating a second percentile ranking associated with at least one of the second entity or the second IP assets based at least in part on comparing the first score to the second score, wherein generating the first percentile ranking and the second percentile ranking comprises determining a minimum value associated with at least one of the first score or the second score and determining a maximum value associated with at least one of the first score or the second score:
generating a graphical user interface (GUI) configured to display on a computing device, the GUI including at least one of the first score, the second score, the first normalized score, the second normalized score, the first percentile ranking, or the second percentile ranking; and
causing the GUI to be displayed via a display of the computing device.

2. The method of claim 1, further comprising:
identifying at least one of a first market or a first technology associated with third IP assets:
determining a respective date associated with individual ones of the third IP assets filed between the first date and the second date:
determining a third average date associated with the third IP assets filed between the first date and the second date:
determining a third amount of time between the third average date and the second date; and
generating a third score associated with at least one of the first market, the first technology, and/or the third IP assets based at least in part on the third amount of time.

3. The method of claim 1, further comprising associating at least one of the first score, the second score, the first normalized score, the second normalized score, the first percentile ranking, or the second percentile ranking with an innovation score, wherein the innovation score is associated with at least one of architectural innovation, incremental innovation, radical innovation, or disruptive innovation.

4. The method of claim 3, further comprising determining at least one of:
a portfolio quality score associated with at least one of the first entity or the second entity:
a filing velocity score associated with at least one of the first entity or the second entity:
a revenue associated with at least one of the first entity or the second entity:
a research and development score associated with at least one of the first entity or the second entity: or
a prosecution cost score associated with at least one of the first entity or the second entity, wherein the innovation score is based at least in part on the portfolio quality score, the filing velocity score, the research and development score, the revenue, the prosecution cost score, the first score, the second score, the first normalized score, the second normalized score, the first percentile ranking, or the second percentile ranking.

5. The method of claim 3, wherein the GUI comprises a quadrant graph comprising:
a first section associated with architectural innovation;
a second section associated with incremental innovation;
a third section associated with radical innovation; and
a fourth section associated with disruptive innovation.

6. The method of claim 1, further comprising determining a number of IP assets associated with the first entity that have been published between the first date and the second date, wherein at least one of the first score, the first percentile ranking, or the first normalized score is based at least in part on the number of IP assets associated with the first entity that have been published between the first date and the second date.

7. The method of claim 1, wherein at least one of the first score, the second score, the first normalized score, the second normalized score, the first percentile ranking, or the second percentile ranking is determined using machine learning.

8. The method of claim 1, wherein at least one of the first score, the second score, the first normalized score, the second normalized score, the first percentile ranking, or the second percentile ranking is determined using a quadratic regression.

9. A method comprising:
identifying a market associated with first IP assets:
determining a respective date associated with individual ones of the first IP assets filed between a first date and a second date, the respective date comprising at least one of a filing date, a publication date, or a priority date:
determining a first average date associated with the first IP assets filed between the first date and the second date:
determining a first amount of time between the first average date and the second date:
generating a first score associated with the market based at least in part on the first amount of time:
identifying an entity associated with the market:
determining a second number of second IP assets filed by the entity between the first date and the second date, the second IP assets being associated with the market:
determining a respective date associated with individual ones of the second IP assets filed between the first date and a second date:
determining a second average date associated with the second IP assets filed between the first date and the second date:
determining a second amount of time between the second average date and the second date:
generating a second score associated with the entity based at least in part on the second amount of time:
generating a graphical user interface (GUI) configured to display on a computing device, the GUI including at least one of the first score or the second score; and
causing the GUI to be displayed via a display of the computing device.

10. The method of claim 9, wherein at least one of the first score or the second score is associated with at least one of architectural innovation, incremental innovation, radical innovation, or disruptive innovation.

11. The method of claim 10, further comprising determining a maturity score associating with the market, wherein the at least one of the first score or the second score is based at least in part on the maturity score.

12. The method of claim 9, wherein the GUI comprises a quadrant comprising:
a first section associated with architectural innovation;
a second section associated with incremental innovation;
a third section associated with radical innovation; and
a fourth section associated with disruptive innovation.

13. The method of claim 9, wherein at least one of the first score or the second score is based at least in part on a number of IP assets associated with the market that have been published between the first date and the second date.

14. The method of claim 9, wherein the at least one of the first score or the second score is determined using machine learning.

15. The method of claim 9, wherein the at least one of the first score or the second score is determined using a quadratic regression.

16. A system comprising:
one or more processors; and
one or more non-transitory computer-readable media comprising instructions that, when executed by the one or more processors, cause the one or more processors to perform operations comprising:
identifying at least one of an entity or a market associated with IP assets;
determining a respective date associated with individual ones of the IP assets filed between a first date and a second date, the respective date comprising at least one of a filing date, a publication date, or a priority date:
determining an average date associated with the IP assets filed between the first date and the second date:
determining an amount of time between the average date and the second date:
generating a score associated with the at least one entity or market based at least in part on the amount of time;
determining a market maturity associated with the at least one entity or market:
determining an input to a machine learning model based at least in part on the score and the market maturity; and
determining an output from the machine learning model based at least in part on the input.

17. The system of claim 16, further comprising associating the score with an innovation score, wherein the innovation score is associated with at least one of architectural innovation, incremental innovation, radical innovation, or disruptive innovation.

18. The system of claim 17, further comprising determining at least one of a portfolio quality score associated with the at least one entity or market, a filing velocity score associated with the at least one entity or market, a revenue associated with the at least one entity or market, a research and development score associated with the at least one entity or market, or a prosecution cost score associated with the at least one entity or market, wherein the innovation score is based at least in part on the portfolio quality score, the filing velocity score, the research and development score, the revenue, the prosecution cost score, the score, or the market maturity.

19. The system of claim 16, further comprising:
generating a graphical user interface (GUI) configured to display on a computing device, the GUI including at least one of the score and the market maturity; and
causing the GUI to be displayed via a display of the computing device, wherein the GUI comprises a quadrant comprising:
a first section associated with architectural innovation;
a second section associated with incremental innovation;
a third section associated with radical innovation; and
a fourth section associated with disruptive innovation.

20. The system of claim 17, further comprising determining a number of IP assets associated with the at least one entity or market that have been published between the first date and the second date, wherein the score is based at least in part on the number of IP assets associated with the at least one entity or market that have been published between the first date and the second date.
